(19) United States
(12) Patent Application Publication
(10) Pub. No.: US 2020/0104964 A1
(43) Pub. Date: Apr. 2, 2020

(54) PICK-UP/DROP-OFF MANAGEMENT DEVICE, PICK-UP/DROP-OFF MANAGEMENT METHOD, AND PROGRAM

(71) Applicant: HONDA MOTOR CO., LTD., Minato-ku, Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/621,458

(22) PCT Filed: Jun. 15, 2018
(86) PCT No.: PCT/JP2018/022829

§ 371 Date: Dec. 11, 2019

(30) Foreign Application Priority Data
Jun. 16, 2017 (JP) 2017-118698

(51) Int. Cl. G06Q 50/30; G06Q 10/02; G06Q 10/06; G08G 1/127; G01C 21/34

(52) U.S. Cl. CPC G06Q 50/30; G06Q 10/02; G01C 21/3407; G08G 1/127; G06Q 10/06312

(57) ABSTRACT

An aspect of the present invention is a pick-up/drop-off management device (400) including a vehicle allocation reserver (432) configured to create a pick-up/drop-off schedule on the basis of content of a reservation for a facility and reserve a vehicle, and a vehicle allocation manager (433) configured to allocate the vehicle reserved by the vehicle allocation reserver according to the pick-up/drop-off schedule.

### TECHNICAL FIELD

Aspects of the present invention relates to a pick-up/drop-off management device, a pick-up/drop-off management method, and a program.

Priority is claimed on Japanese Patent Application No. 2017-118698, filed Jun. 16, 2017, the content of which is incorporated herein by reference.

### BACKGROUND

When a user moves to a hotel or restaurant at a travel destination or the like, taxis, rental cars, pick-up/drop-off vehicles prepared at the hotel, and the like are used. For example, a system that supports payment of a charge according to a travel route of a rental car when a guest who has reserved a hotel is picked up or dropped off at the hotel using a rental car is known (see Patent Literature 1).

### CITATION LIST

### Patent Literature

### [Patent Literature 1]

Japanese Unexamined Patent Application, First Publication No. 2002-099661

### SUMMARY OF INVENTION

### Technical Problem

However, when a taxi is not able to pick up or the number of pick-up and drop-off times of a pick-up and drop-off vehicle is small, a user may wait for a long time. Further, users who cannot drive cannot use rental cars.

The present invention has been made in consideration of such circumstances, and an object of the present invention is to provide a pick-up and drop-off service linked to a reserved facility.

### Solution to Problem

A pick-up/drop-off management device, a pick-up/drop-off management method, and a program according to the present invention have adopted the following configurations.

(1) An aspect of the present invention is a pick-up/drop-off management device including: a vehicle allocation reserver configured to create a pick-up/drop-off schedule on the basis of content of a reservation for a facility and reserve a vehicle; and a vehicle allocation manager configured to allocate the vehicle reserved by the vehicle allocation reserver according to the pick-up/drop-off schedule.

(2) In the aspect (1), the vehicle allocation reserver creates the pick-up/drop-off schedule allowing a vehicle to arrive in time for a designated arrival time, with the facility set as a destination or a departure place, on the basis of the content of the reservation for the facility.

(3) In the aspect (1), the pick-up/drop-off management device further include: an acquirer configured to acquire a movement situation from the vehicle allocated by the vehicle allocation manager; and a status manager configured to notify at least one of a user terminal used by a user who has made the reservation for the facility and a facility terminal used by an administrator of the facility of the movement situation acquired by the acquirer.

(4) In the aspect (3), the status manager notifies the facility terminal that a user has got on the vehicle allocated by the vehicle allocation manager and then has started a movement to the facility, or of a target time of arrival at the facility.

(5) In the aspect (3), the status manager accepts at least one of change or cancelation of a reservation for vehicle allocation and change or cancelation of the reservation for the facility when an arrival time of the vehicle allocated by the vehicle allocation manager is delayed.

(6) In the aspect (5), the status manager accepts both the cancelation of the vehicle allocation and the cancelation of the facility when neither the cancelation of the vehicle allocation nor extension of a usage time of the facility is acceptable from the user notified of the delay in the arrival time of the vehicle allocated by the vehicle allocation manager.

(7) In the aspect (3), the acquirer acquires information indicating the number of occupants from the vehicle, and the status manager notifies the facility terminal of change of the number of reserved persons when the information indicating the number of occupants acquired by the acquirer is different from the number of reserved persons.

(8) In the above (3), the acquirer acquires an order indication for a service or product provided by the facility from the vehicle, and the status manager notifies the facility terminal of the order indication acquired by the acquirer.

(9) In the aspect (3), the pick-up/drop-off management device further includes: a service information acquirer configured to acquire service provision information including point information corresponding to a service provision point, identification information of the service provider, and identification information of a user of the service provider from the service provider; an access point acquirer configured to acquire an access point that is information on the point at which the user receives the service provision; and a plan determiner configured to determine an operation plan of the vehicle corresponding to a route between the point information and the access point.

(10) In the aspect (9), the pick-up/drop-off management device further includes a status manager configured to generate service status information corresponding to the service information and the identification information of the user acquired by the acquirer, and provide the service status information to the server provider at least on the route of the vehicle.

(11) In the aspect (10), the plan determiner acquires the identification information of the user associated with the service status information, generates the service status information on the basis of an operation plan of the vehicle determined by the plan determiner, and makes the plan.

(12) In the aspect (11), the plan determiner manages status attributes discriminated from identification information of the user and the movement situation as the service status information, and makes the plan.

(13) In the aspect (10), the plan determiner notifies the facility terminal of information on a time of arrival at the facility in the service status information.

(14) A pick-up/drop-off management method including: creating a pick-up/drop-off schedule on the basis of content of a reservation for a facility and reserving a vehicle; and allocating the reserved vehicle according to the pick-up/drop-off schedule.

(15) A program causing a computer to: create a pick-up/drop-off schedule on the basis of content of a reservation for a facility and reserve a vehicle; and allocate the reserved vehicle according to the pick-up/drop-off schedule.

### Advantageous Effects of Invention

With the inventions according to claims 1, 2, 14, and 15, it is possible to provide a pick-up/drop-off service linked to a reserved facility.

With the present invention according to claims 3 and 4, the user can confirm a vehicle allocation situation or a delay situation and determine a subsequent action, and an administrator of a facility can improve a service by being prepared to greet the user according to the arrival of the user.

With the present invention according to claims 5 and 6, the user can simply change or cancel a reservation for a facility or pick-up/drop-off vehicle when a pick-up/drop-off vehicle is delayed.

With the inventions according to claims 7 and 8, it is possible to instruct change of the number of persons or an order for a facility before arrival at the facility.

With the inventions according to claims 9, 10, 11, 12, and 13, the user can receive an additional service during a pick-up/drop-off service through the service provider.

### BRIEF DESCRIPTION OF DRAWINGS

FIG. 1 is a configuration diagram of a vehicle allocation system 1.

FIG. 2 is a configuration diagram of a vehicle 100.

FIG. 3 is a diagram showing an automated driving process.

FIG. 4 is a functional configuration diagram of a facility terminal 200.

FIG. 5 is a functional configuration diagram of a user terminal 300.

FIG. 6 is a diagram showing an example of a facility reservation screen.

FIG. 7 is a diagram showing an example of a vehicle allocation reservation screen.

FIG. 8 is a functional configuration diagram of a pick-up/drop-off management device 400.

FIG. 9 is a diagram showing an example of facility reservation information 421.

FIG. 10 is a diagram showing an example of vehicle allocation reservation information 422.

FIG. 11 is a diagram showing an example of vehicle allocation status information 423.

FIG. 12 is a diagram showing an example of movement status information 425.

FIG. 13 is a flowchart showing an example of a processing operation in the vehicle 100.

FIG. 14 is a flowchart showing an example of a processing operation in the vehicle 100.

FIG. 15 is a flowchart showing an example of a processing operation in the pick-up/drop-off management device 400.

FIG. 16 is a flowchart showing an example of a processing operation in the pick-up/drop-off management device 400.

FIG. 17 is a flowchart showing an example of processing operations in the pick-up/drop-off management device 400.

FIG. 18 is a diagram showing an example in which the vehicle allocation system 1 has been used.

FIG. 19 is a diagram showing another example in which the vehicle allocation system 1 has been used.

FIG. 20 is a functional configuration diagram of a service provider device 600.

FIG. 21 is a functional configuration diagram of a service management device 700.

FIG. 22 is a functional configuration diagram of a vehicle control device 910.

FIG. 23 is a flowchart showing an example of a flow of a process that is executed in a vehicle allocation system 1A.

### DESCRIPTION OF EMBODIMENTS

Hereinafter, embodiments of a pick-up/drop-off management device, a pick-up/drop-off management method, and a program according to the present invention will be described with reference to the drawings. A vehicle to be allocated in the present system is, for example, an automated driving vehicle that basically does not require a driving operation. Further, the vehicle to be allocated stands by at a vehicle station prepared in each of places in a state in which the vehicle has not been allocated, and moves to a vehicle station with a vacancy near the destination and stands by after arriving at the destination.

### First Embodiment

Hereinafter, a pick-up/drop-off management device 400 of a first embodiment will be described.

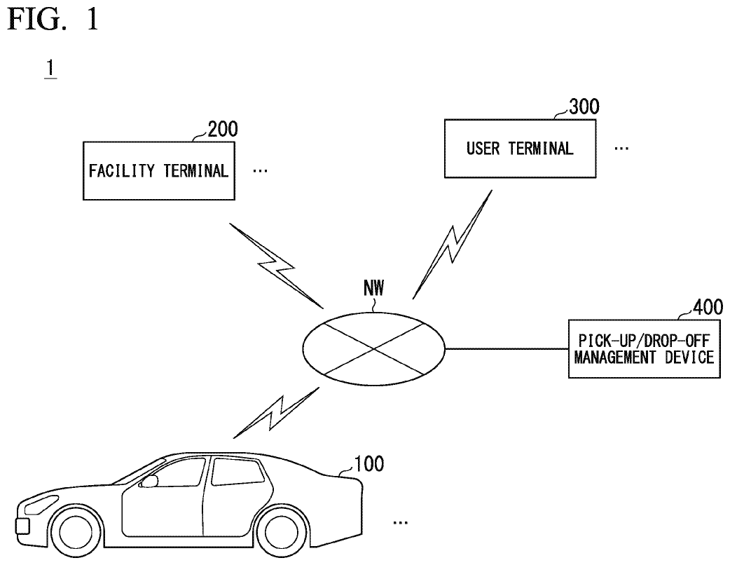

FIG. 1 is a configuration diagram of a vehicle allocation system 1. The vehicle allocation system 1 includes one or more vehicles 100, one or more facility terminals 200, one or more user terminals 300, and a pick-up/drop-off management device 400. These components can communicate with each other via a network NW. The network NW includes the Internet, a wide area network (WAN), a local area network (LAN), a public line, a provider device, a dedicated line, a wireless base station, and the like.

### [Vehicle]

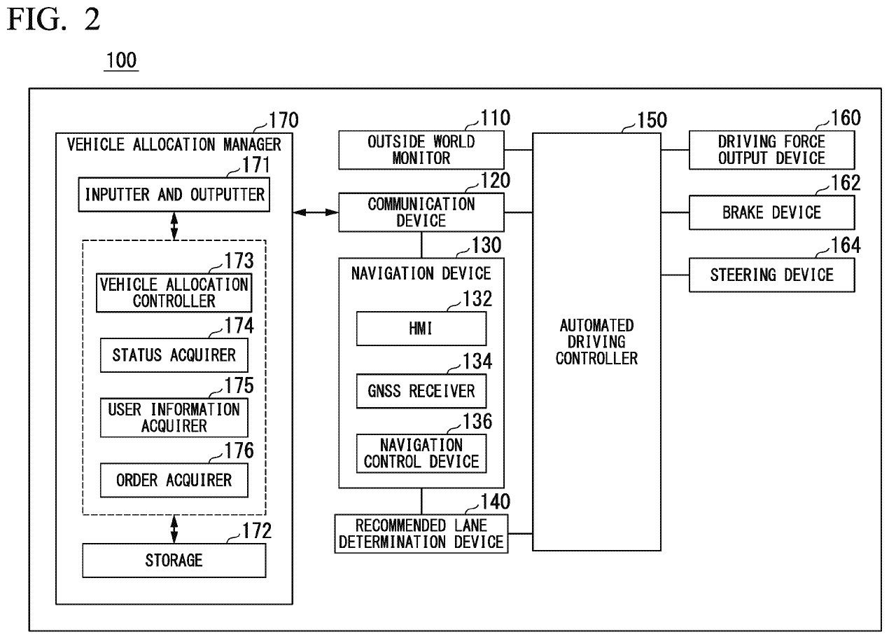

The vehicle 100 is, for example, a vehicle having four or more wheels on which a plurality of users are allowed to get. FIG. 2 is a configuration diagram of the vehicle 100. The vehicle 100 includes, for example, an outside world monitor 110, a communication device 120, a navigation device 130, a recommended lane determination device 140, an automated driving controller 150, a driving force output device 160, a brake device 162, a steering device 164, and a vehicle allocation manager 170.

The outside world monitor 110 includes, for example, a camera, a radar, a light detection and ranging (LIDAR), and an object recognition device that performs a sensor fusion process on the basis of outputs thereof. The outside world monitor 110 estimates types of object (particularly, vehicles, pedestrians, and bicycles) present around the vehicle 100 and outputs information indicating the types to the automated driving controller 150 together with information on positions or speeds thereof.

The communication device 120 is, for example, a wireless communication module for connection to a network NW or direct communication with another vehicle, a terminal device of a pedestrian, or the like. The communication device 120 performs wireless communication on the basis of Wi-Fi, dedicated short range communications (DSRC), Bluetooth (registered trademark), or another communication standard. As the communication device 120, a plurality of communication devices may be prepared according to purposes.

The navigation device 130 includes, for example, a human machine interface (HMI) 132, a global navigation satellite system (GNSS) receiver 134, and a navigation control device 136. The HMI 132 includes, for example, a touch panel type display device, a speaker, or a microphone. The GNSS receiver 134 measures its own position (a position of the vehicle 100) on the basis of radio waves coming from a GNSS satellite (for example, a GPS satellite). The navigation control device 136 includes, for example, a central processing unit (CPU) or various storage devices, and controls the entire navigation device 130. Map information (navigation map) is stored in the storage device. The navigation map is a map representing roads with nodes and links.

The navigation control device 136 determines a route from the position of the vehicle 100 measured by the GNSS receiver 134 to a destination designated using the vehicle allocation manager 170 by referring to the navigation map. The destination may be designated by the user using the HMI 132. Further, the navigation control device 136 may transmit the position and the destination of the vehicle 100 to a navigation server (not shown) or the pick-up/drop-off management device 400 using the communication device 120 and acquire the route returned from the navigation server or the pick-up/drop-off management device 400. The route may include information on a point at which the vehicle stops to allow the user to get on or off the vehicle and a target time of arrival at the point. The navigation control device 136 outputs the information on the route determined by any one of the above methods to the recommended lane determination device 140.

The recommended lane determination device 140 includes, for example, a micro processing unit (MPU) and various storage devices. Detailed map information with a higher accuracy than that of the navigation map is stored in the storage devices. The high-accuracy map information includes, for example, information such as road widths, gradients, curvatures, and position of traffic signals for each lane. The recommended lane determination device 140 determines a recommended lane that is preferable for the vehicle to travel along the route input from the navigation device 130, and outputs the recommended lane to the automated driving controller 150.

The automated driving controller 150 includes one or more processors such as a CPU or an MPU, and various storage devices. The automated driving controller 150 causes the vehicle 100 to travel automatically so that contact with an object of which the position or the speed has been input from the outside world monitor 110 is avoided, with a rule that the vehicle travels in the recommended lane determined by the recommended lane determination device 140. The automated driving controller 150 sequentially executes various events, for example. The events include, for example, a constant-speed traveling event in which a vehicle travels on the same travel lane at a constant speed, a following traveling event in which a vehicle travels following a preceding vehicle, a lane changing event, a merging event, a branching event, an emergency stopping event, a toll gate event for passing through a toll gate, and a handover event for ending automated driving and performing switching to manual driving. Further, an action for avoidance may be planned on the basis of a surrounding situation of the vehicle 100 (presence of nearby vehicles or pedestrians, lane narrowing due to road construction, or the like) during execution of these events.

The automated driving controller 150 generates a target trajectory in which the vehicle 100 will travel in the future. The target trajectory includes, for example, a speed element. For example, the target trajectory is represented as a sequential arrangement of points (trajectory points) to be reached by a host vehicle M. The trajectory points are points to be reached by the host vehicle M for each of predetermined traveling distances. A target speed and a target acceleration for each predetermined sampling time (for example, every several tenths of a [sec]) are separately generated as a part of the target trajectory. Further, the trajectory point may be a position to be reached by the host vehicle M at a sampling time for each of predetermined sampling times. In this case, information on the target speed or the target acceleration is represented by an interval between the trajectory points.

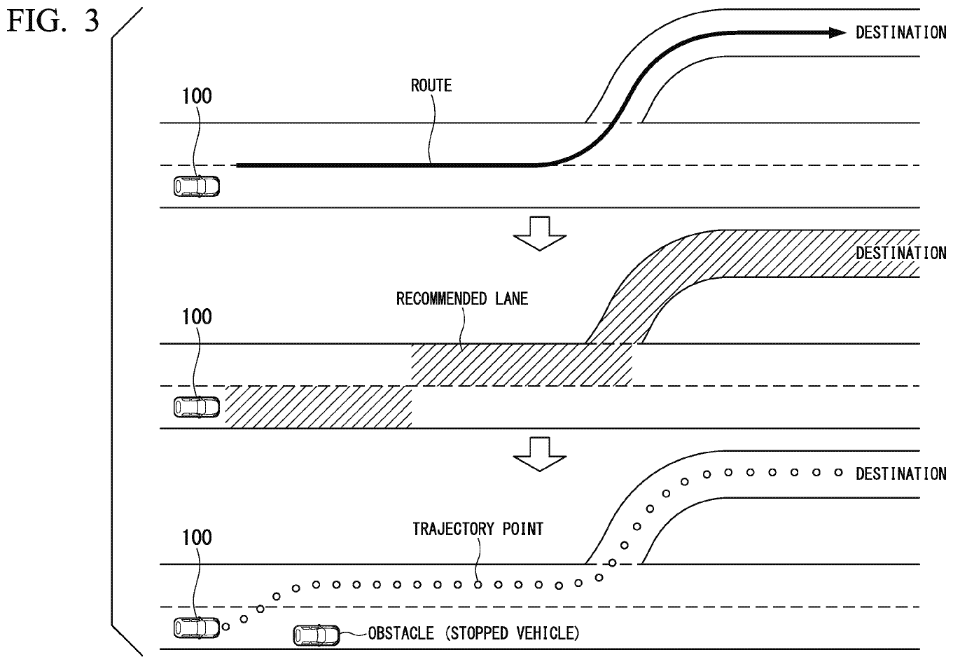

FIG. 3 is a diagram showing an automated driving process. First, as shown in the upper figure, the route is determined by the navigation device 130. This route is, for example, a rough route in which there is no distinction between lanes. Then, as shown in the middle figure, the recommended lane determination device 140 determines recommended lanes that are easy to travel in along the route. As shown in the lower figure, the automated driving controller 150 generates trajectory points for traveling along recommended lanes as far as possible while performing avoidance of obstacles, or the like, and controls some or all of the driving force output device 160, the brake device 162, and the steering device 164 so that the vehicle travels according to the trajectory points (and an ancillary speed profile). Such role sharing is merely an example, and for example, the automated driving controller 150 may perform the process in a centralized manner.

The driving force output device 160 outputs a travel driving force (torque) for traveling of the vehicle to driving wheels. The driving force output device 160 includes, for example, a combination of an internal combustion engine, an electric motor, a transmission, and the like, and a power ECU that controls these. The power ECU controls the above configuration according to information input from the automated driving controller 150 or information input from a driving operator (not shown).

The brake device 162 includes, for example, a brake caliper, a cylinder that transfers hydraulic pressure to the brake caliper, an electric motor that generates the hydraulic pressure in the cylinder, and a brake ECU. The brake ECU controls the electric motor according to information input from the automated driving controller 150 or information input from the driving operator so that a brake torque according to a braking operation is output to each wheel. The brake device 162 may include a mechanism that transfers the hydraulic pressure generated by an operation of a brake pedal included in the driving operator to the cylinder via a master cylinder, as a backup. The brake device 162 is not limited to the configuration described above and may be an electronically controlled hydraulic brake device that controls an actuator according to information input from the automated driving controller 150 and transfers the hydraulic pressure of the master cylinder to the cylinder.

The steering device 164 includes, for example, a steering ECU and an electric motor. The electric motor, for example, applies a force to a rack and pinion mechanism to change directions of steerable wheels. The steering ECU drives the electric motor according to the information input from the automated driving controller 150 or the information input from the driving operator to change the directions of the steerable wheels.

The vehicle allocation manager 170 includes an inputter and outputter 171, a storage 172, a vehicle allocation controller 173, a status acquirer 174, a user information acquirer 175, and an order acquirer 176.

The inputter and outputter 171 includes an inputter such as a mouse, a keyboard, a touch panel, a microphone, a sensor, and a camera, and an outputter such as a display and a speaker. The storage 172 is realized by a hard disk drive (HDD), a flash memory, a random access memory (RAM), a read only memory (ROM), or the like.

The vehicle allocation controller 173, the status acquirer 174, the user information acquirer 175, and the order acquirer 176 are realized by, for example, a processor such as a CPU executing a program (software) stored in the storage 172. Further, some or all of these functional units may be realized by hardware such as a large scale integration (LSI), an application specific integrated circuit (ASIC), a field-programmable gate array (FPGA), or a graphics processing unit (GPU) or may be realized by software and hardware in cooperation.

The vehicle allocation controller 173 sets navigation setting information in the navigation control device 136 on the basis of a pick-up/drop-off schedule received from the pick-up/drop-off management device 400 using the communication device 120. The pick-up/drop-off schedule is a schedule for causing a pick-up/drop-off vehicle reserved in connection with a reservation for a facility to travel according to content of the reservation for the facility, and includes position information on a pick-up position, a time of arrival at the pick-up position, position information of a destination, a time of arrival at the destination, the number of occupants, and the like. The pick-up position is a position at which the user is caused to get on. The navigation setting information includes a pick-up position, a time of arrival at the pick-up position, a destination, a time of arrival at the destination, and the like.

The status acquirer 174 acquires information including a movement situation of the vehicle (hereinafter referred to as status information) and transmits the status information to the pick-up/drop-off management device 400 using the communication device 120. The status information includes, for example, information in which a date and time is associated with the position of the vehicle 100 measured by the GNSS receiver 134, or information indicating a target arrival time acquired by the navigation control device 136. Further, the status acquirer 174 may acquire a vehicle allocation status or an arrival situation on the basis of position information of the vehicle 100 measured by the GNSS receiver 134, the navigation setting information, and the like, and include the vehicle allocation status or the arrival situation in the status information. Examples of the vehicle allocation status include pick-up, waiting for get-on, waiting for partial get-on, get-on completion, moving, and movement completion. Examples of the arrival situation include on-time, delay, and delay during a traffic jam. The vehicle allocation status may be input by the user using the inputter and outputter 171 or may be a result of analysis of the status acquirer 174 on the basis of detection results of a sensor or an image or a video captured by the camera.

The user information acquirer 175 acquires information on the user (hereinafter referred to as user information), for example, using the inputter and outputter 171, and transmits the information to the pick-up/drop-off management device 400 using the communication device 120. Examples of the user information include the number of occupants, a sex of the user, an age of the user, a race of the user, preferences or impressions of the user, a questionnaire about a facility, the number or weight of packages, presence or absence of a wheelchair, and presence or absence of a stroller. For example, the user information acquirer 175 may acquire the number of occupants, a sex of the user, and the like by analyzing, for example, a detection result of a sensor or an image or a video captured by the camera. Further, the user information acquirer 175 may acquire a degree of excitement of conversation of the user in the vehicle, a degree of satisfaction or emotion of the user, and the like by analyzing, for example, sound data detected by a microphone.

The order acquirer 176, for example, acquires information for indicating an order for a service or a product provided by the facility (hereinafter, referred to as order indication information) using the inputter and outputter 171, and transmits the order indication information to the pick-up/drop-off management device 400 using the communication device 120. Accordingly, the user getting on the vehicle 100 can order a thing or service that is provided when the user arrives at the facility, using an online menu in advance.

### [Facility Terminal]

The facility terminal 200 is a terminal that is installed in a facility that can be reserved by a user, and is a terminal that is used by an administrator of the facility. Examples of the facility include hotels, inns, restaurants, hospitals, beauty salons, and culture schools. The facility terminal 200 is, for example, a personal computer, a smartphone, or a tablet terminal.

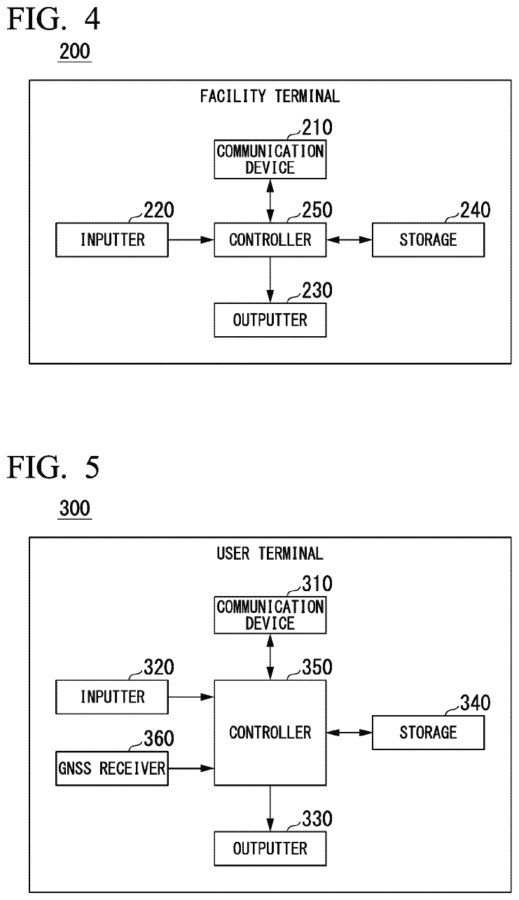

FIG. 4 is a functional configuration diagram of the facility terminal 200. The facility terminal 200 includes, for example, a communication device 210, an inputter 220, an outputter 230, a storage 240, and a controller 250.

The communication device 210 is, for example, a communication interface for connection to the network NW or direct communication with the pick-up/drop-off management device 400. The communication device 210 may include, for example, a network interface card (NIC), or may perform wireless communication on the basis of Wi-Fi, dedicated short range communications (DSRC), Bluetooth (registered trademark), or other communication standards. As the communication device 210, a plurality of communication devices may be prepared according to applications.

The inputter 220 includes, for example, a keyboard, a mouse, a touch panel, and a microphone. The outputter 230 includes, for example, a display and a speaker. The storage 240 is realized by an HDD, flash memory, a RAM, a ROM, or the like.

The controller 250 is realized, for example, by a processor such as a CPU executing a program (software) stored in the storage 240. Further, some or all of these functional units may be realized by hardware such as an LSI, an ASIC, an FPGA, or a GPU or may be realized by software and hardware in cooperation. For example, the controller 250 displays, on the outputter 230, a web page browsed with a browser, an application page browsed with an application program, or the like on the basis of information received from the pick-up/drop-off management device 400.

### [User Terminal]

The user terminal 300 is a terminal that is used by the user. The user terminal 300 is, for example, a personal computer, a smartphone, or a tablet terminal. FIG. 5 is a functional configuration diagram of the user terminal 300. The user terminal 300 includes, for example, a communication device 310, an inputter 320, an outputter 330, a storage 340, a controller 350, and a GNSS receiver 360. Components which are the same in the vehicle 100 and the facility terminal 200 are denoted by the same names, and detailed description thereof will be omitted.

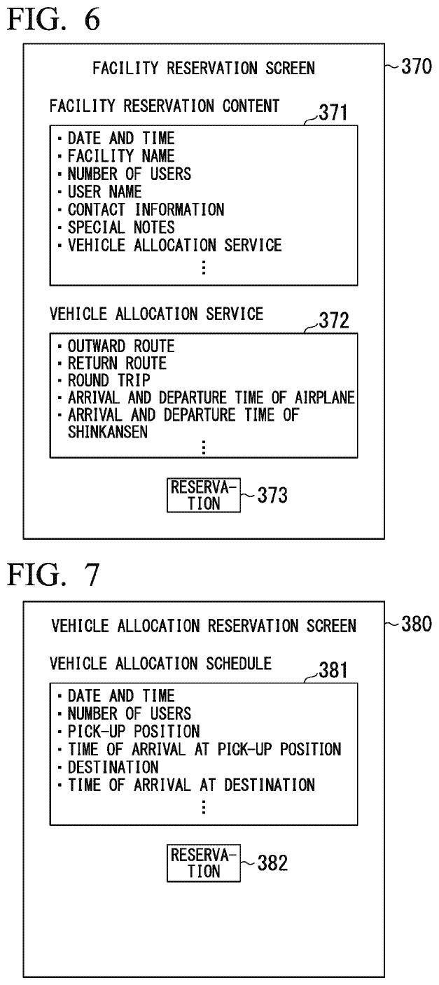

An example of an operation screen displayed on the outputter 330 of the user terminal 300 will be described herein with reference to FIGS. 6 and 7. FIG. 6 is a diagram showing an example of a facility reservation screen. The facility reservation screen 370 is an operation screen that is displayed when a facility reservation is requested by a user using the inputter 320. The facility reservation screen 370 includes facility reservation content 371, pick-up/drop-off service content 372, and a reservation button 373.

The facility reservation content 371 is an operation screen that displays items necessary for a reservation for a facility and accepts a selection or input from the user for each item. The facility reservation content 371 includes items such as a date and time, a facility name, the number of users, a user name, contact information, special notes, and pick-up/drop-off service.

The pick-up/drop-off service content 372 is an operation screen that displays items necessary for a reservation for vehicle allocation and accepts a selection or input from the user for each item. The pick-up/drop-off service content 372 includes, for example, an item for selecting any one of an outward route, a return route, or both, and an item for selecting an arrival or departure time at a pick-up position, a destination, or the like of a station or an airport.

The reservation button 373 is an operation button for accepting a reservation with the content displayed in the facility reservation content 371 or the pick-up/drop-off service content 372. When the reservation button 373 is operated, the controller 350 creates facility reservation information on the basis of the reservation content displayed in the facility reservation content 371 or the pick-up/drop-off service content 372, and transmits the facility reservation information to the pick-up/drop-off management device 400 using the communication device 310.

After transmitting the facility reservation information, the controller 350 causes the outputter 330 to display a vehicle allocation reservation screen on the basis of information received from the pick-up/drop-off management device 400 using the communication device 310. In the embodiment, an example in which a pick-up/drop-off schedule created by the pick-up/drop-off management device 400 on the basis of the facility reservation information is displayed on the vehicle allocation reservation screen, the user is caused to confirm the pick-up/drop-off content, and then, a reservation for the pick-up/drop-off vehicle is accepted will be described, but the present invention is not limited thereto. For example, the pick-up/drop-off management device 400 may accept both a reservation for the facility and the reservation for the pick-up/drop-off vehicle by receiving the facility reservation information without causing the user to confirm the pick-up/drop-off content.

FIG. 7 is a diagram showing an example of the vehicle allocation reservation screen. A vehicle allocation reservation screen 380 is an operation screen that displays the pick-up/drop-off schedule created by the pick-up/drop-off management device 400 on the basis of the facility reservation information. The vehicle allocation reservation screen 380 includes pick-up/drop-off content 381 and a reservation button 382.

The pick-up/drop-off content 381 is an operation screen that displays the pick-up/drop-off schedule created by the pick-up/drop-off management device 400 for each item necessary for a reservation for vehicle allocation and accepts editing of a part of the pick-up/drop-off schedule from the user. The pick-up/drop-off content 381 includes items such as a date and time, the number of users, a pick-up position, a time of arrival at the pick-up position, a destination, and a time of arrival at the destination.

The reservation button 382 is an operation button for accepting a reservation with content displayed in the pick-up/drop-off content 381. When the reservation button 382 is operated, the controller 350 creates vehicle allocation reservation information on the basis of reservation content displayed in the pick-up/drop-off content 381 and transmits the vehicle allocation reservation information to the pick-up/drop-off management device 400 using the communication device 310. Here, when there is no change in the pick-up/drop-off content, the controller 350 may include that fact in the vehicle allocation reservation information or may include only a change point of the pick-up/drop-off content in the vehicle allocation reservation information.

### [Pick-Up/Drop-Off Management Device]

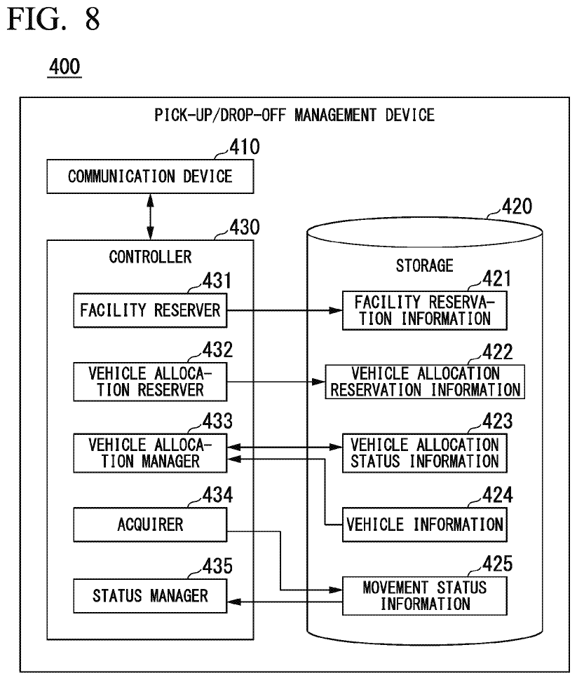

Next, the pick-up/drop-off management device 400 will be described with reference to FIGS. 8 to 12. FIG. 8 is a functional configuration diagram of the pick-up/drop-off management device 400. The pick-up/drop-off management device 400 includes, for example, a communication device 410, a storage 420, and a controller 430. The communication device 310 is, for example, an NIC for connection to the network NW. The communication device 310 communicates with the vehicle 100, the facility terminal 200, and the user terminal 300 via the network NW. The storage 420 is realized by an HDD, a flash memory, a RAM, a ROM, and the like.

The controller 430 includes a facility reserver 431, a vehicle allocation reserver 432, a vehicle allocation manager 433, an acquirer 434, and a status manager 435. Some or all of these components are realized, for example, by a processor such as a CPU executing a program (software) stored in the storage 420. Further, some or all of these functional units may be realized by hardware such as an LSI, an ASIC, an FPGA, or a GPU or may be realized by software and hardware in cooperation.

The facility reserver 431 reserves the facility on the basis of facility reservation information received from the user terminal 300 via the communication device 410 and the network NW. The facility reservation information is content of a reservation for a facility that is reserved by the user, and includes, for example, a reservation date and time, a name or address of the facility, the number of reserved persons, a name of the user, contact information, special notes, and a pick-up/drop-off service. In a process of reserving a facility, the facility reserver 431 may acquire a vacancy situation of a facility designated by the user by referring to an external server connected via the network NW, and transmit the availability to the user terminal 300. The facility reserver 431 stores various types of information in the facility reservation information 421 in the storage 420 on the basis of the received facility reservation information. Further, the facility reserver 431 may create information indicating a reliability of a user on the basis of a previous facility reservation situation of the user and include the information in the facility reservation information 421. The reliability of the user includes, for example, an evaluation value according to a reservation cancelation rate or an evaluation value according to a use frequency.

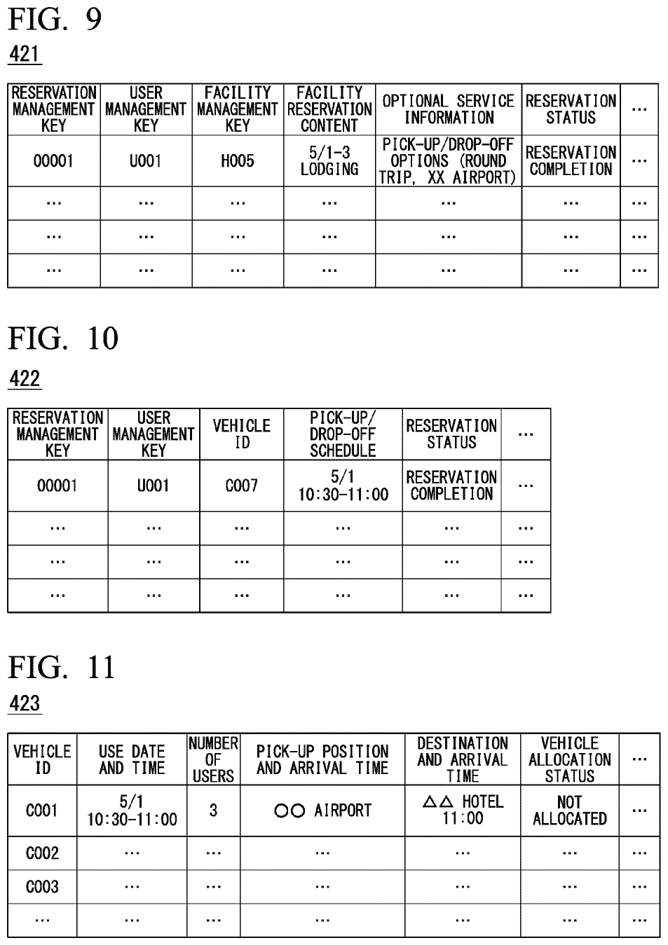

The facility reservation information 421 is information indicating reservation content of each facility. FIG. 9 is a diagram showing an example of the facility reservation information 421. As shown in FIG. 9, the facility reservation information 421 is information in which a user management key, a facility management key, facility reservation content, optional service information, and a reservation status are associated with a reservation management key. The reservation management key is unique information for identifying each reservation. The user management key is unique information for identifying each user. The facility management key is unique information for identifying each facility. Content of the facility reservation includes a reservation date and time, a name or address of the facility, the number of reserved persons, a name of the user, contact information, special notes, and the like. The optional service information includes information indicating whether or not an optional service such as a pick-up service is desired to be provided. The reservation status is information indicating a status of the facility reservation, and includes, for example, reservation preparation, reservation completion, and cancelation completion.

The vehicle allocation reserver 432 creates a pick-up/drop-off schedule on the basis of the facility reservation information received from the user terminal 300 via the communication device 410 and the network NW, and reserves a pick-up/drop-off vehicle in the facility. The vehicle allocation reserver 432 reserves a pick-up/drop-off vehicle for an outward route, a return route, or both for the facility on the basis of a designation of the user. The vehicle allocation reserver 432 may transmit the pick-up/drop-off schedule created on the basis of the facility reservation information to the user terminal 300 before reserving the pick-up/drop-off vehicle, receive a reservation instruction from the user, and then, reserve the pick-up/drop-off vehicle.

The vehicle allocation reserver 432 creates a pick-up/drop-off schedule allowing the vehicle to arrive in time for a designated arrival time, with the facility set as a destination or a departure place, on the basis of the facility reservation information. For example, the vehicle allocation reserver 432 determines the pick-up/drop-off schedule such as a reservation date and time of the pick-up/drop-off vehicle, the number of reserved persons, the pick-up position or the destination, and a time of arrival at the pick-up position or the destination, on the basis of the reservation date and time, the number of reserved persons, the name of the facility, and the like included in the facility reservation information. In addition to the facility reservation information, the vehicle allocation reserver 432 may receive, for example, information on the movement means to the facility (for example, an airplane or a Shinkansen) from the user terminal 300, create a pick-up/drop-off schedule to a hotel according to a time of arrival at an airport or a pick-up/drop-off schedule to a restaurant according to a time of arrival at a station, and transmit the pick-up/drop-off schedule to the user terminal 300. The vehicle allocation reserver 432 stores various types of information in the vehicle allocation reservation information 422 in the storage 420 on the basis of the created pick-up/drop-off schedule when the vehicle allocation has been reserved on the basis of the created pick-up/drop-off schedule. Further, the vehicle allocation reserver 432 may create information indicating the reliability of the user on the basis of a previous vehicle allocation reservation situation of the user and include the information in the vehicle allocation reservation information 422.

The vehicle allocation reservation information 422 is information indicating the reservation content of each pick-up/drop-off vehicle. FIG. 10 is a diagram showing an example of the vehicle allocation reservation information 422. As shown in FIG. 10, the vehicle allocation reservation information 422 is information in which a user management key, a vehicle ID, a pick-up/drop-off schedule, and a reservation status are associated with a reservation management key. The vehicle ID is unique information for identifying each vehicle.

The vehicle allocation manager 433 allocates the pick-up/drop-off vehicle reserved by the vehicle allocation reserver 432 on the basis of the reservation content. The vehicle allocation of the vehicle allocation manager 433 includes a process of allocating a pick-up/drop-off vehicle for picking up/dropping off a user according to each pick-up/drop-off schedule (hereinafter referred to as an allocation process), and a process of instructing the allocated pick-up/drop-off vehicle to perform automated driving according to the pick-up/drop-off schedule (hereinafter referred to as a driving instruction process).

In the allocation process, the vehicle allocation manager 433 reads reservation content corresponding to a predetermined allocation period (for example, a period from 0:00 to 24:00 on the next day) from the vehicle allocation reservation information 422, and allocates a relevant vehicle 100 for each pick-up/drop-off schedule included in the read information. For example, the vehicle allocation manager 433 selects a vehicle of a type on which a reserved number of users can get, which is a vehicle that can travel to the pick-up position and the destination so that the vehicle arrives in time for a reserved arrival time from among the vehicles 100 registered in vehicle information 424 on the basis of a reservation situation. The vehicle information 424 is information on the vehicle 100 and is, for example, information in which a vehicle ID, a vehicle station in which the vehicle 100 is parked, a current position (latitude, longitude, and altitude) of the vehicle 100, an address necessary for communication with the vehicle 100, and a traveling status have been associated with each other.

Further, the vehicle allocation manager 433 may allocate a vehicle 100 that allows a movement distance from a previous destination to a next pick-up position to be minimized so that no delay is shown in the pick-up/drop-off schedule due to, for example, a traffic jam on roads other than a pick-up/drop-off road. Further, the vehicle allocation manager 433 may allocate the vehicles 100 so that a predetermined number of vehicles 100 necessary for pick-up/drop-off for a facility in a predetermined range are caused to stand by at a predetermined vehicle station. The vehicle allocation manager 433 associates content of the allocated pick-up/drop-off schedule with the vehicle ID of the relevant vehicle 100, and writes the content to vehicle allocation status information 423. All vehicle allocation statuses indicate non-allocation immediately after the content is written to the vehicle allocation status information 423.

When the pick-up/drop-off schedule is created, the vehicle allocation reserver 432 may create a schedule suitable for pick-up/drop-off of the vehicle, which is a pick-up/drop-off schedule in which a pick-up/drop-off vehicle can be allocated, by referring to both the facility reservation information 421 and the vehicle allocation status information 423, in a case in which a reservation time included in the facility reservation information is included in the allocation period. For example, the vehicle allocation reserver 432 creates a first schedule including a reservation date and time of the pick-up/drop-off vehicle, the number of reserved persons, the pick-up position or the destination, a time of arrival at the pick-up position or the destination, and the like on the basis of the reservation date and time, the number of reserved persons, the name of the facility, and the like included in the facility reservation information 421, and sets the first schedule as the pick-up/drop-off schedule when there is a vehicle 100 that can be allocated according to the first schedule. On the other hand, when there is no vehicle 100 that can be allocated according to the first schedule, the vehicle allocation reserver 432 creates a second schedule by changing a part or all of the first schedule so that the vehicle 100 can be allocated, and sets the second schedule as the pick-up/drop-off schedule. Accordingly, when a facility is reserved several days ago, a pick-up/drop-off vehicle can be reserved according to a schedule according to a desire of the user regardless of the status of the vehicle 100, and when a facility is reserved several hours ago, a pick-up/drop-off vehicle can be reserved according to a schedule allowing vehicle allocation.

In the driving instruction process, the vehicle allocation manager 433 transmits a driving start instruction together with the pick-up/drop-off schedule to the vehicle 100 using the communication device 410 at a predetermined timing, and rewrites the vehicle allocation status in the vehicle allocation status information 423 during pick-up/drop-off.

The vehicle allocation status information 423 includes information on to a vehicle reserved for allocation or a vehicle that is being allocated and includes, for example, information set in the vehicle 100 or information indicating a vehicle allocation situation. FIG. 11 is a diagram showing an example of the vehicle allocation status information 423. As shown in FIG. 11, the vehicle allocation status information 423 is information in which a use date and time, the number of users, a pick-up position and a time of arrival at the pick-up position, a destination and a time of arrival at the destination, and a vehicle allocation status have been associated with a vehicle ID. The vehicle allocation status is information indicating a vehicle allocation situation of the allocated vehicle 100, and is updated by the vehicle allocation manager 433, for example.

The acquirer 434 acquires the movement situation, the vehicle allocation status, the arrival status, and the like from the vehicle 100 allocated by the vehicle allocation manager 433. For example, the acquirer 434 receives the status information periodically transmitted from the vehicle 100 using the communication device 410, and writes various types of information to movement status information 425 of the storage 420 on the basis of the received status information.

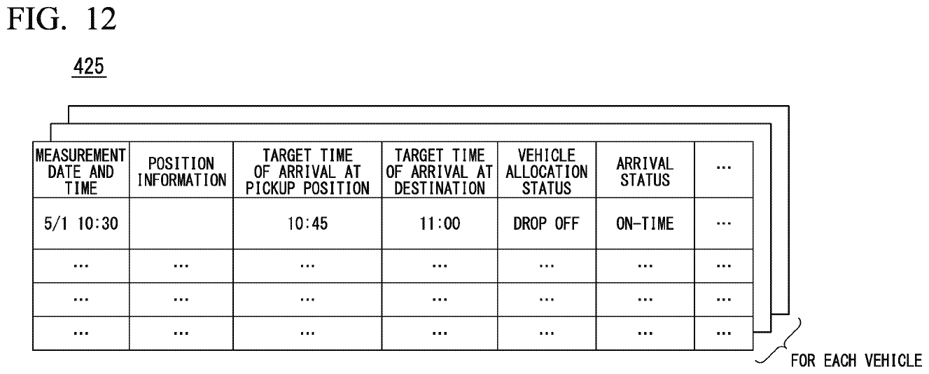

The movement status information 425 is information indicating a situation of the vehicle 100 that is being allocated. FIG. 12 is a diagram showing an example of the movement status information 425. As shown in FIG. 12, the movement status information 425 is information in which current position information of the vehicle 100, a target time of arrival at the pick-up position at a current point in time, a target time of arrival at the destination at a current point in time, a vehicle allocation status, and an arrival status are associated with a measurement date and time, and is stored in, for example, a table prepared for each vehicle 100. The measurement date and time is a date and time when the status information has been created in the vehicle 100. The position information is information indicating the position of the vehicle 100 measured by the GNSS receiver 134 of the vehicle 100 at the measurement date and time. The target arrival time is a target arrival time derived by the navigation control device 136 of the vehicle 100 at the measurement date and time. The arrival status is information indicating an arrival situation of the allocated vehicle 100, and is, for example, an arrival situation acquired by the status acquirer 174 of the vehicle 100 at the measurement date and time.

The status manager 435 notifies at least one of the user terminal 300 and the facility terminal 200 of the movement situation acquired by the acquirer 434, using the communication device 410. The status manager 435 may notify of a message according to the vehicle allocation status at a timing at which the vehicle allocation status has changed, by referring to the movement status information 425, or may notify of a message according to the arrival status at a timing at which the vehicle 100 is delayed. For example, the status manager 435 notifies the facility terminal 200 that a movement to the facility has started or of a target time of arrival at the facility after the user has got on the vehicle 100 allocated by the vehicle allocation manager 433.

The status manager 435 determines whether or not the number of occupants is different from the number of reserved persons on the basis of information indicating the number of occupants acquired by the acquirer 434, and notifies the facility terminal 200 of change of the number of reserved persons when the number of occupants is different from the number of reserved persons. Further, the status manager 435 notifies the corresponding facility terminal 200 of the order indication information acquired by the acquirer 434.

When the time of arrival at the pick-up position or the time of arrival at the destination of the vehicle 100 allocated by the vehicle allocation manager 433 is delayed, the status manager 435 notifies at least one of the user terminal 300 and the facility terminal 200 of the fact, and receives at least one of a change or cancelation of the reservation for the vehicle allocation, or a change or cancelation of the reservation for the facility. The change includes extension of a usage time, postponement of a use date, a change of the pick-up position or the destination, and the like. Further, the status manager 435 may accept both of the cancelation of the vehicle allocation and the cancelation of the facility when neither of the cancelation or the change of the vehicle allocation nor the change of the reservation for the facility is not acceptable from the user notified of the delay in the time of arrival at the pick-up position or the time of arrival at the destination of the vehicle 100 allocated by the vehicle allocation manager 433.

The status manager 435 updates the vehicle allocation status of the vehicle allocation status information 423 at a timing at which the vehicle allocation status has changed by referring to the movement status information 425.

### [Flowchart]

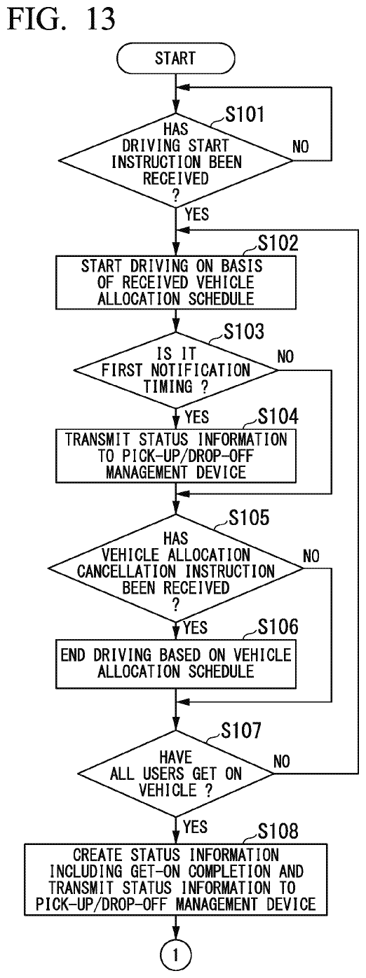

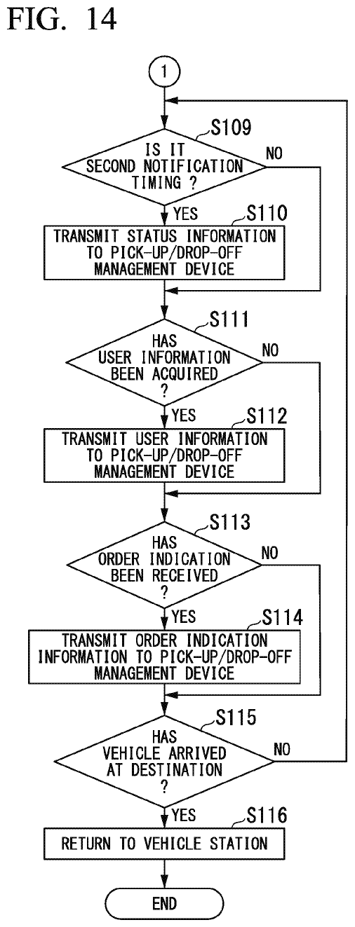

Next, an example of a processing operation in the vehicle 100 will be described with reference to FIGS. 13 and 14. FIGS. 13 and 14 are flowcharts showing an example of a processing operation in the vehicle 100.

First, the vehicle allocation controller 173 determines whether or not the driving start instruction has been received from the pick-up/drop-off management device 400 using the communication device 120 (step S101). When the vehicle allocation controller 173 has determined that the driving start instruction has been received, the vehicle allocation controller 173 instructs the navigation device 130 and the automated driving controller 150 to start driving on the basis of the pick-up/drop-off schedule received together with the driving start instruction (step S102). Accordingly, a route according to a pick-up position or a destination according to the pick-up/drop-off schedule and a time of arrival at the pick-up position or the destination is set in the navigation device 130, and the automated driving controller 150 starts automated driving according to the set route.

The status acquirer 174 determines whether or not it is a predetermined first notification timing (step S103). The first notification timing is a predetermined timing at which the vehicle 100 notifies the status information during pick-up. Examples of the first notification timing include a timing at which automated driving has been started, a timing at which a target time of arrival at the pick-up position is after a reserved arrival time, a timing at which the vehicle has arrived at the pick-up position, a timing at which the user is caused to get on the vehicle 100, and a timing at which a predetermined time has elapsed since a previous notification. When the status acquirer 174 has determined that it is the first notification timing, the status acquirer 174 acquires the status information and transmits the status information to the pick-up/drop-off management device 400 using the communication device 120 (step S104).

The vehicle allocation controller 173 determines whether or not a vehicle allocation cancelation instruction has been received from the pick-up/drop-off management device 400 using the communication device 120 (step S105). When the vehicle allocation controller 173 has received the vehicle allocation cancelation instruction, the vehicle allocation controller 173 instructs the navigation device 130 and the automated driving controller 150 to end the automated driving according to the set route (step S106). Here, the navigation device 130 may accept a setting of a new destination from the user using the HMI 132. When the vehicle allocation controller 173 has received the change of the pick-up position or the destination and an instruction to change a time of arrival at the pick-up position or the destination from the pick-up/drop-off management device 400 using the communication device 120, the vehicle allocation controller 173 instructs the navigation device 130 and the automated driving controller 150 to change the navigation setting information.

The status acquirer 174 determines whether or not all the users get on the vehicle 100 (step S107). For example, the status acquirer 174 determines that all the users have got on the vehicle 100 when all of predetermined pick-up positions are passed on the basis of the position of the vehicle 100 measured by the GNSS receiver 134. Further, the status acquirer 174 may determine that all the users have got on the vehicle 100 when the user has input the fact that all the users have got on the vehicle 100 using the inputter and outputter 171 or when the number of occupants obtained from a result of analyzing an image obtained by imaging the inside of the vehicle matches the number of reserved users. When the status acquirer 174 has determined that all the users get in the vehicle 100, the status acquirer 174 creates status information including an indication that the vehicle allocation status indicates get-on completion, and transmits the status information to the pick-up/drop-off management device 400 using the communication device 120 (step S108).

The status acquirer 174 determines whether or not it is a predetermined second notification timing (step S109). The second notification timing is a predetermined timing at which the status information is notified of while all the users get in the vehicle 100. Examples of the second notification timing include a timing at which all the users are caused to get in the vehicle 100, a timing at which the target time of arrival at the destination is after a reserved arrival time, and a timing at which a predetermined time has elapsed since a previous notification. When the status acquirer 174 has determined that it is the second notification timing, the status acquirer 174 acquires the status information and transmits the status information to the pick-up/drop-off management device 400 using the communication device 120 (step S110).

The user information acquirer 175 determines whether or not user information has been acquired (step S111). For example, when an input of the number of occupants and a sex or age of the user has been accepted from the user using the inputter and outputter 171, the user information acquirer 175 creates user information including the number of occupants and the sex or age of the user, and transmits the user information to the pick-up/drop-off management device 400 using the communication device 120 (step S112).

The order acquirer 176 determines whether or not the order indication information has been acquired (step S113). For example, when at least one menu has been selected from among online menus by the user using the inputter and outputter 171, the order acquirer 176 creates order indication information for requesting an order of the selected menu, and transmits the order indication information to the pick-up/drop-off management device 400 using the communication device 120 (step S114).

The vehicle allocation controller 173 determines whether or not the vehicle has arrived at the destination on the basis of the output from the navigation control device 136 (step S115). When the position of the vehicle 100 measured by the GNSS receiver 134 falls in a predetermined range of the destination, the navigation control device 136 notifies the vehicle allocation controller 173 that the vehicle 100 has arrived at the destination. When the vehicle allocation controller 173 is notified that the vehicle has arrived at the destination, the vehicle allocation controller 173 sets the vehicle station as a next destination and instructs the navigation device 130 and the automated driving controller 150 to perform automated driving (step S116). When a new pick-up/drop-off schedule has been received during a movement toward the vehicle station, the vehicle allocation controller 173 proceeds to step S101.

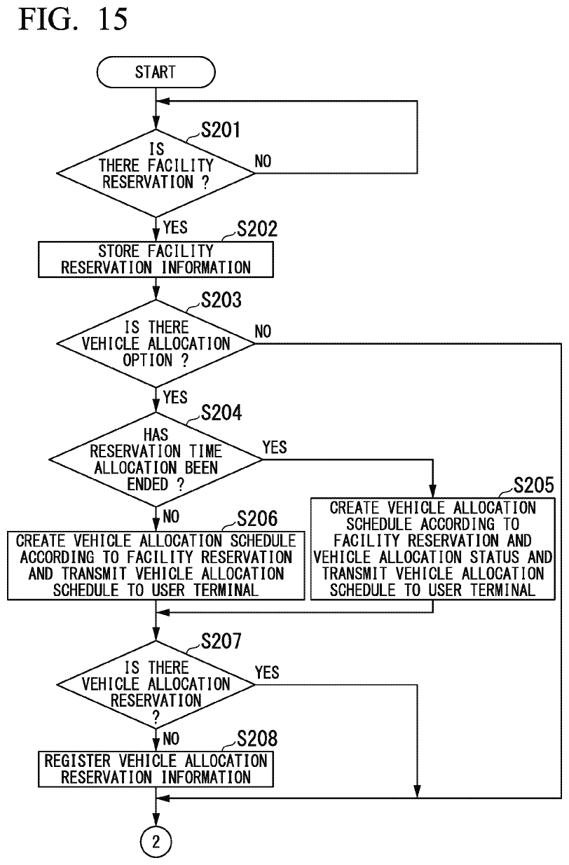

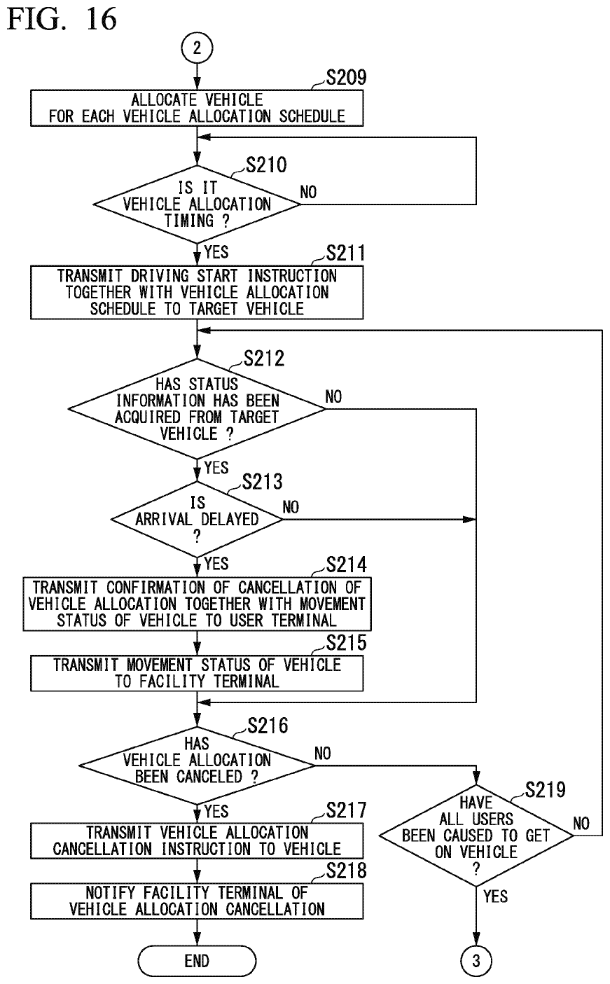

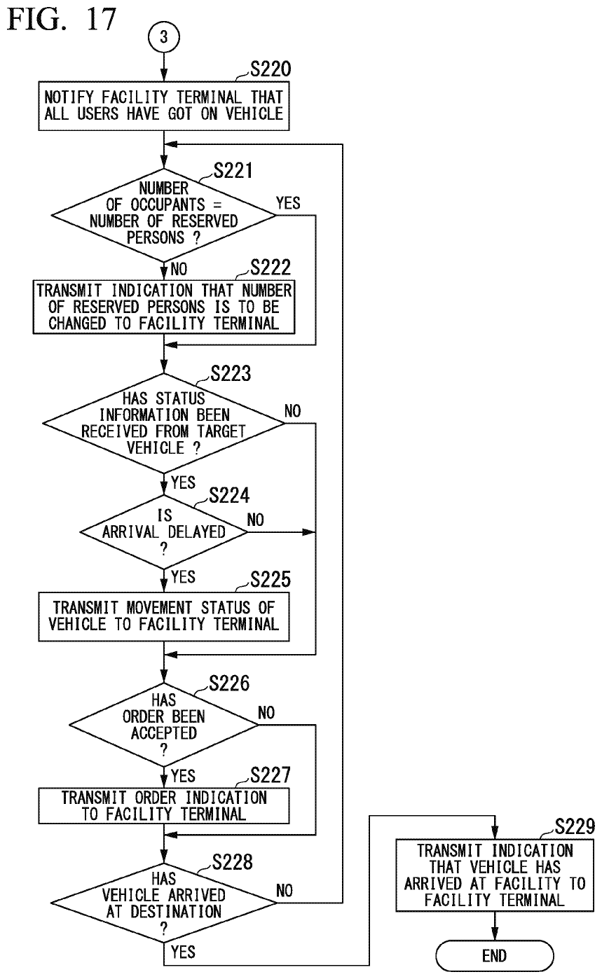

Next, an example of a processing operation in the pick-up/drop-off management device 400 will be described with reference to FIGS. 15, 16, and 17. FIGS. 15, 16, and 17 are flowcharts showing an example of the processing operation in the pick-up/drop-off management device 400.

First, the facility reserver 431 determines whether or not facility reservation information has been received from the user terminal 300 using the communication device 410 (step S201). When the facility reserver 431 has determined that the facility reservation information has been received, the facility reserver 431 determines whether or not a facility having content shown in the received facility reservation information can be reserved, by referring to an external server that manages facility reservation. When the facility can be reserved, the facility reserver 431 stores various types of information in the facility reservation information 421 of the storage 420 on the basis of the received facility reservation information (step S202). Accordingly, the facility having the content shown in the facility reservation information is reserved. When the facility cannot be reserved, the facility reserver 431 may notify the user terminal 300 of the fact using the communication device 410 and accept reservation with other content.

Then, the facility reserver 431 determines whether or not the received facility reservation information includes content indicating that a pick-up/drop-off service is desired to be provided (step S203). When the facility reserver 431 has determined that the facility reservation information includes the content indicating that a pick-up/drop-off service is desired to be provided, the facility reserver 431 instructs the vehicle allocation reserver 432 to create the pick-up/drop-off schedule. The vehicle allocation reserver 432 determines whether or not the reservation time included in the facility reservation information is included in an allocation period in which the allocation process has already been ended (step S204). When the reservation time is not included in the allocation period in which the allocation process has already been ended, the vehicle allocation reserver 432 creates a pick-up/drop-off schedule by referring to the facility reservation information 421, and transmits the pick-up/drop-off schedule to the user terminal 300 using the communication device 410 (step S205). On the other hand, when the reservation time is included in the allocation period in which the allocation process has already been ended, the vehicle allocation reserver 432 creates a pick-up/drop-off schedule in which the vehicle 100 can be allocated, by referring to both the facility reservation information 421 and the vehicle allocation status information 423, and transmits the pick-up/drop-off schedule to the user terminal 300 using the communication device 410 (step S206).

The vehicle allocation reserver 432 determines whether or not a vehicle allocation reservation instruction has been received from the user terminal 300 using the communication device 410 (step S207). When the vehicle allocation reserver 432 has determined that the vehicle allocation reservation instruction has been received, the vehicle allocation reserver 432 stores reserved content in the vehicle allocation reservation information 422 of the storage 420 on the basis of the pick-up/drop-off schedule transmitted to the user terminal 300 (step S208). Accordingly, a pick-up/drop-off vehicle in the reserved facility is reserved.

The vehicle allocation manager 433 executes an allocation process and writes various types of information to the vehicle allocation status information 423 (step S209). Then, the vehicle allocation manager 433 determines whether or not it is a vehicle allocation timing by referring to the vehicle allocation reservation information 422 (step S210). The vehicle allocation timing is a time at which the pick-up/drop-off vehicle is caused to move to the pick-up position, and is derived by reversely calculating a time of a movement from the current position of the vehicle 100 to the pick-up position so that the vehicle arrives at the pick-up position before a determined arrival time. When it is the vehicle allocation timing, the vehicle allocation manager 433 transmits the driving start instruction together with the pick-up/drop-off schedule read from the vehicle allocation reservation information 422 to the vehicle 100 using the communication device 410 (step S211). Further, the vehicle allocation manager 433 rewrites the vehicle allocation status corresponding to the vehicle ID of the allocated vehicle 100 in the vehicle allocation status information 423 during pick-up.

The status manager 435 determines whether or not new status information has been acquired by the acquirer 434 by referring to the movement status information 425 (step S212). When the status manager 435 determines that the new status information has been acquired, the status manager 435 determines whether or not arrival at the pick-up position is delayed (step S213). For example, the status manager 435 compares a latest target time of arrival at the pick-up position stored in the movement status information 425 with a time of arrival at the pick-up position stored in the vehicle allocation status information 423.

When the status manager 435 has determined that the arrival at the pick-up position is delayed, the status manager 435 transmits information for confirming cancelation of the vehicle allocation or facility reservation or change of the vehicle allocation or facility reservation, together with the movement situation of the vehicle 100, to the user terminal 300 using the communication device 410 (step S214). For example, the status manager 435 transmits, to the user terminal 300, a movement situation including the target time of arrival at the pick-up position, the current position information of the vehicle 100, the target time of arrival at the destination, and the like. Then, the status manager 435 transmits the movement situation of the vehicle 100 to the facility terminal 200 using the communication device 410 (step S215). For example, the status manager 435 transmits a movement situation including a target time of arrival at the facility or a delayed time to the facility terminal 200.

On the other hand, when the status manager 435 has determined in step S212 that the status information has not been acquired, the vehicle allocation manager 433 determines whether or not the vehicle allocation cancelation instruction has been received from the user terminal 300 using the communication device 410 (step S216). When the vehicle allocation cancelation instruction has been received, the vehicle allocation manager 433 transmits the vehicle allocation cancelation instruction to the vehicle 100 using the communication device 410 (step S217). Further, the vehicle allocation manager 433 transmits an indication that the vehicle allocation has been canceled to the facility terminal 200 using the communication device 410 (step S218). Here, the vehicle allocation manager 433 may receive an instruction to change the reservation for vehicle allocation from the user terminal 300 and transmit content of the change to the vehicle 100 and the facility terminal 200. Further, the vehicle allocation manager 433 may receive an instruction to cancel the reservation for the facility or change the reservation, together with the instruction to cancel the vehicle allocation or change the vehicle allocation reservation, from the user terminal 300 using the communication device 410, and transfer the fact to the facility terminal 200.

On the other hand, when the vehicle allocation manager 433 has determined in step S216 that the vehicle allocation cancelation instruction or the like has not been received, the status manager 435 determines whether or not a movement status indicating get-on completion has been received from the user terminal 300 using the communication device 410 (step S219). When the status manager 435 has determined that the movement status indicating get-on completion has not been received, the status manager 435 returns to step S212 and repeats the process.

When the status manager 435 has determined in step S219 that the movement status indicating get-on completion has been received, the status manager 435 transmits an indication that all the users have got on the vehicle 100 to the facility terminal 200 using the communication device 410 (step S220). Then, the status manager 435 determines whether or not the number of occupants is equal to a scheduled number on the basis of the status information or the user information received from the vehicle 100 using the communication device 410 (step S221). When the number of occupants is not equal to the number of reserved persons, the status manager 435 transmits an indication that the number of reserved persons is to be changed to the number of occupants to the facility terminal 200 using the communication device 410 (step S222).

Then, the status manager 435 determines whether or not status information has been received from the vehicle 100 using the communication device 410 (step S223). When the status manager 435 determines that the status information has been received, the status manager 435 determines whether or not a target time of arrival at a destination is after a reserved time on the basis of the received status information (step S224). When the status manager 435 has determined that the target time of arrival at the destination is after the reserved time, the status manager 435 transmits the movement situation of the vehicle 100 to the facility terminal 200 using the communication device 410 (step S225).

Then, the status manager 435 determines whether or not an order indication has been received from the vehicle 100 using the communication device 410 (step S226). When the status manager 435 has determined that the order indication has been received, the status manager 435 transmits the order indication to the facility terminal 200 using the communication device 410 (step S227).

Then, the status manager 435 determines whether or not status information indicating that the vehicle has arrived at the destination has been received from the vehicle 100 using the communication device 410 (step S228). When the status manager 435 has determined that the status information indicating that the vehicle has arrived at the destination has been received, the status manager 435 rewrites the vehicle allocation status in the vehicle allocation status information 423 and the movement status information 425 as the movement completion, and transmits an indication that the vehicle has arrived at the destination to the facility terminal 200 using the communication device 410 (step S229).

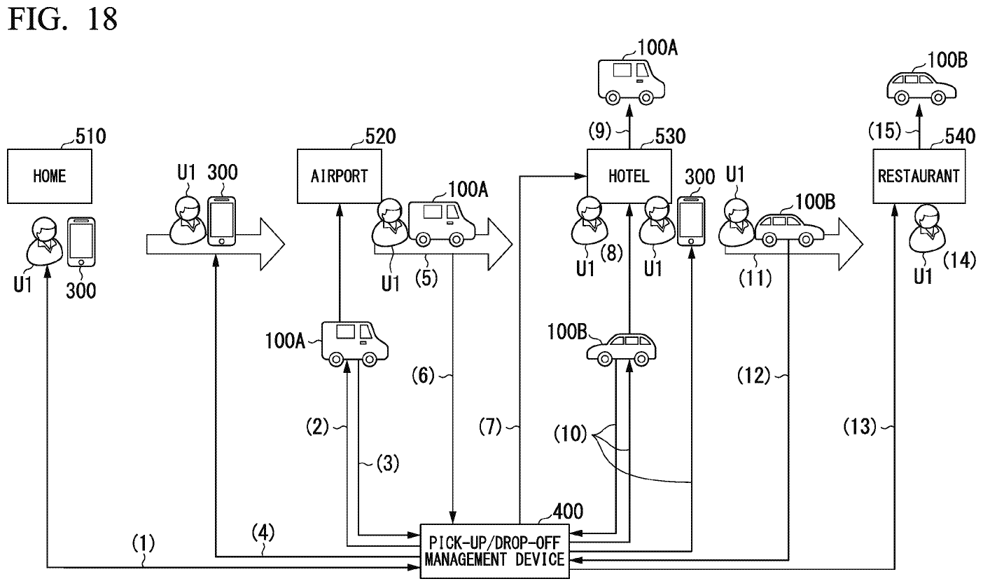

Next, an overview of the vehicle allocation system 1 will be described with reference to FIG. 18. FIG. 18 is a diagram showing an example in which the vehicle allocation system 1 has been used. In the example shown in FIG. 18, it is assumed that lodging at a hotel 530, a meal at a restaurant 540, a pick-up/drop-off vehicle from an airport 520 to the hotel 530, and a pick-up/drop-off vehicle from the hotel 530 to the restaurant 540 have been reserved.

(1) First, a user U1 transmits the facility reservation information and the vehicle allocation reservation information to the pick-up/drop-off management device 400 using the user terminal 300 at a home 510 to make a reservation for the facility and the pick-up/drop-off vehicle.

(2) The pick-up/drop-off management device 400 causes a pre-allocated vehicle 100A to move to the airport 520 that is the pick-up position when it is the vehicle allocation timing.

(3) The vehicle 100A acquires status information such as a movement situation and notifies the pick-up/drop-off management device 400 of the status information.

(4) When the arrival of the vehicle 100A at the airport 520 is delayed, the pick-up/drop-off management device 400 notifies the facility terminal 200 of the hotel 530 and the user terminal 300 of the user U1 of the fact. For example, when the user terminal 300 has instructed the pick-up/drop-off management device 400 to cancel the vehicle allocation, the pick-up/drop-off management device 400 notifies the vehicle 100A of the vehicle allocation cancelation to instruct the vehicle 100A to move to the vehicle station, and notifies the facility terminal 200 of the hotel 530 of the fact.

(5) When the vehicle 100A has arrived at the airport 520, the vehicle 100A notifies the user terminal 300 of the user U1 and the pick-up/drop-off management device 400 of, for example, information indicating that the vehicle 100A has arrived or information indicating a place at which the vehicle 100A is parking. The pick-up/drop-off management device 400 transfers the received content to the facility terminal 200 of the hotel 530. The user U1 gets on the vehicle 100A and then the vehicle 100A departs toward the hotel 530.

(6) The vehicle 100A notifies the pick-up/drop-off management device 400 of the fact that the user U1 has got on the vehicle 100A, other movement situations, or the like. The pick-up/drop-off management device 400 transfers the received content to the facility terminal 200 of the hotel 530.

(7) When the arrival of the vehicle 100A at the hotel 530 is delayed, the pick-up/drop-off management device 400 notifies the facility terminal 200 of the hotel 530 to the fact.

(8) When the vehicle 100A has arrived at the hotel 530, the vehicle 100A notifies the pick-up/drop-off management device 400 of, for example, information indicating that the vehicle 100A has arrived or the user U1 has got off. The pick-up/drop-off management device 400 transfers the received content to the facility terminal 200 of the hotel 530.

(9) The vehicle 100A moves toward the vehicle station or a pick-up position for a next vehicle allocation reservation.

(10) Thereafter, the pick-up/drop-off management device 400 allocates the vehicle 100B according to a reservation time of the restaurant 540, and notifies the user terminal 300 that the vehicle 100B moves toward the hotel 530, which is the pick-up position. The vehicle 100A acquires a movement situation and notifies the pick-up/drop-off management device 400 of the movement situation, while moving to the hotel 530. When arrival at the hotel 530 is delayed, the pick-up/drop-off management device 400 notifies the user terminal 300 to the fact.

(11) When the vehicle 100B has arrived at the hotel 530, the vehicle 100B notifies the user terminal 300 and the pick-up/drop-off management device 400 of, for example, information indicating that the vehicle 100B has arrived, or information indicating a place at which the vehicle 100B is parking. When the user U1 has got on the vehicle 100B, the vehicle 100B departs toward the restaurant 540.

(12) The vehicle 100B notifies the pick-up/drop-off management device 400 of the fact that the user U1 has got on the vehicle 100B, other movement situations, or the like.

(13) When the arrival of the vehicle 100B at the restaurant 540 is delayed or when an indication of an order of an online menu is accepted, the pick-up/drop-off management device 400 notifies the facility terminal 200 to the fact.

(14) When the vehicle 100B has arrived at the restaurant 540, the vehicle 100B notifies the pick-up/drop-off management device 400 of, for example, information indicating that the vehicle 100B has arrived at the restaurant 540 or the user U1 has got off.

(15) The vehicle 100B moves toward the vehicle station or the pick-up position for the next vehicle allocation reservation.

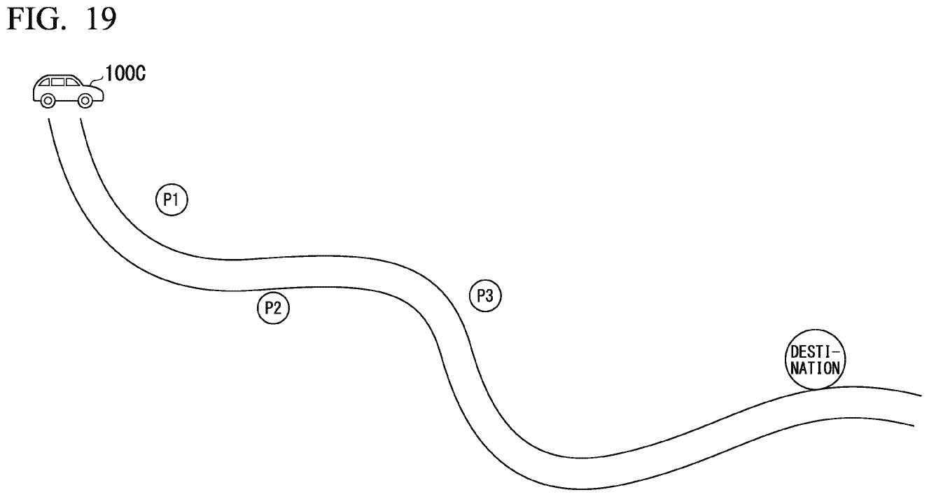

Next, another example of the vehicle allocation system 1 will be described with reference to FIG. 19. FIG. 19 is a diagram showing another example in which the vehicle allocation system 1 has been used. As shown in FIG. 19, a vehicle 100C may cause users to get on the vehicle 100C at a plurality of pick-up positions P1, P2, and P3 and move toward the destination.

According to the first embodiment described above, it is possible to provide a pick-up/drop-off service linked to the reserved facility by including the vehicle allocation reserver 432 that creates the pick-up/drop-off schedule on the basis of the content of the reservation for the facility and reserves the vehicle, and the vehicle allocation manager 433 that allocates the vehicle reserved by the vehicle allocation reserver 432 according to the pick-up/drop-off schedule.

Since the user can make a vehicle allocation reservation according to the facility reservation, according to the pick-up/drop-off schedule created on the basis of the facility reservation information by the pick-up/drop-off management device 400, it is possible to secure a means for a movement to the facility. Further, since the pick-up/drop-off schedule is created on the basis of the facility reservation information, it is not necessary to input detailed information for a vehicle allocation reservation, and it is possible to reduce an effort of the user. Further, the facility side can provide the pick-up/drop-off vehicle as a part of the service to enhance the ability to attract customers, and the user side can also curb costs for a transportation means.

The user can acquire a vehicle allocation situation or a delay situation of the vehicle from the moving vehicle 100 to confirm the vehicle allocation situation or the delay situation and determine a subsequent action.

The facility side can acquire a movement situation such as a get-on situation of the user, a delay situation of the vehicle 100, and a target arrival time from the moving vehicle 100 to prepare to greet the user according to the arrival of the user and improve a service.

The user can simply change or cancel the reservation for the facility or the reservation for the pick-up/drop-off vehicle when the pick-up/drop-off vehicle is delayed.

Since the user can change the number of persons or make an order from the moving vehicle 100, it is possible to shorten a standby time in comparison with making an order after the user has arrived at the facility. Further, the facility side can smoothly guide the user by accepting a change of the number of persons or an order in advance. Further, when the order is accepted from the user in the vehicle 100, the facility side may preferentially guide the user who has made an order in advance.

The facility side can provide a service according to an attribute of a user by acquiring user information from the moving vehicle 100. For example, it is possible to prepare seats according to the number, sex, and age of users or to provide a product or service according to preferences of the user.

### Second Embodiment

Hereinafter, a pick-up/drop-off management device 400A of a second embodiment will be described. In the following description, parts having the same functions as those described in the first embodiment are denoted by the same names and reference signs, and specific descriptions thereof will be omitted.

Hereinafter, a description will be given by using an example in which pick-up/drop-off of the user by the vehicle 100 is comprehensively managed by a service provider having the authority to use a part or all of the pick-up/drop-off management device 400 and the facility terminal 200. The pick-up/drop-off management device 400A includes, for example, a pick-up/drop-off management device 400, a service provider device 600, a service management device 700, and a vehicle management device 910.

### [Service Provider]

The service provider provides a user with an additional service other than the pick-up/drop-off at a timing before or during the pick-up/drop-off. In the example shown in FIG. 18, the service provider may be a person in charge on the facility side such as the airport 520, the hotel 530, and the restaurant 540 or may be an administrator of the vehicle 100. Further, the service provider may be a broker that brokers and comprehensively manages a reservation schedule of the vehicle 100, the airport 520, the hotel 530, the restaurant 540, or the like, in addition to providing the additional service.

The additional service provided by the service provider may be, for example, a product or service that the user can enjoy while moving on the vehicle 100, or it may be necessary to stop by a service providing place such as a store during the pick-up/drop-off of the user. The product or service that the user can enjoy while moving is, for example, viewing of a paid information program, or a massage that can be performed in the vehicle 100. Further, the service provider may dispatch a person in charge of service provision to the vehicle 100 in order to provide the product or service that the user can enjoy while moving. Further, a service providing device may be installed in the vehicle 100. The service providing device is, for example, a massage device. The service providing device may be a vending machine having a size for mounting in the vehicle 100.

Further, the service provider may propose a service that can be provided, to the user in the vehicle 100, on the basis of the user information acquired by the user information acquirer 175. For example, when the user seems to be bad as a result of the service provider analyzing the user information acquired by the user information acquirer 175, the service provider may provide medicine or the like from the service providing device. Further, the service provider may cause the inputter and outputter 171 to reproduce a display or sound for proposing a user to stop by a nearby break spot, medical institution, drug store, or the like.

The user may order an additional service to be provided by the service provider before getting on the vehicle 100 (for example, at the time of vehicle allocation reservation), or may order the additional server while the user is getting on the vehicle 100.

When the order acquirer 176 accepts the order for the additional service from the user via the inputter and outputter 171 or the like, the order acquirer 176 transmits content of the order to the service provider device 600 that manages the additional service.

### [Service Provider Device]

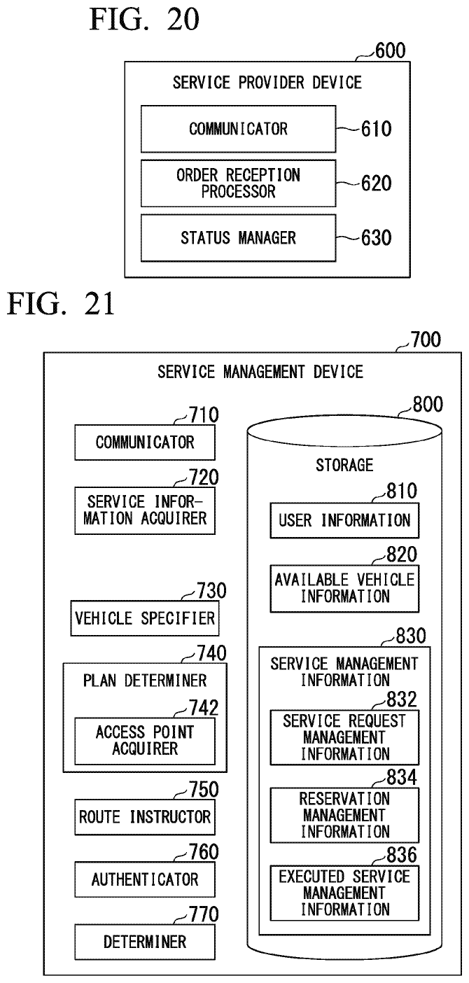

FIG. 20 is a functional configuration diagram of the service provider device 600. The service provider device 600 is, for example, a device that can ascertain a status of a plurality of service providers and automatically respond to an order from the user and a service administrator. The service provider device 600 includes, for example, a communicator 610, an order reception processor 620, a status manager 630, and a storage 650 (not shown).

The communicator 610 communicates with the pick-up/drop-off management device 400 or the like via the network NW. The order reception processor 620 performs an order reception process on a service order from the user. The order reception processor 620 determines whether or not content of the service order is service provision information that has already been transmitted to the pick-up/drop-off management device 400, and first proceeds to the order reception process when the order reception processor 620 has determined that the content of the service order is not the service provision information that has already been transmitted. The status manager 630 manages a status (a reservation status, operating status, or the like) of the service provider registered in the service provider device 600, and provides the service provision information to the service management device 700 and the pick-up/drop-off management device 400. The service management device 700 will be described below.

The service provider device 600 transmits, for example, service provision information including the following content to the service management device 700 and the pick-up/drop-off management device 400. The service provision information is information relevant to a service for which the service provider can receive an order.

### [Service Provision Information]

Identification ID (ID for identifying the service provider)

User ID

Required vehicle compartment information (information on in-vehicle use space required for service provision)

Facility position information

Service provision point information (target facility information)

Service provision time information (reservation information)

User pick-up position

Service status information (information corresponding to an execution situation and progress of the service provided by the service provider)

User setting information (for example, additional information such as an input to the service and remarks)

The service status information corresponds to, for example, a performance situation of each of a plurality of additional services that are performed in the vehicle 100, and is a degree of progress such as a progress percentage and a remaining time in minutes. Further, the service status information may be indicated by a value indicating a status such as “before provision, during provision, provision end”.

The communicator 610 of the service provider device 600 may cause a display device such as the inputter and outputter 171 to switch display content according to communication results. The service provider device 600, for example, causes the inputter and outputter 171 to display that a service provision start time is approaching or that the service provision has started.

### [Service Management Device]

FIG. 21 is a functional configuration diagram of the service management device 700. The service management device 700 includes, for example, a communicator 710, a service information acquirer 720, a vehicle specifier 730, a plan determiner 740, a route indicator 750, an authenticator 760, a determiner 770, and a storage 800. The components other than the communicator 710 and the storage 800 are realized, for example, by a hardware processor such as a CPU executing a program (software). Some or all of these components may be realized by hardware (including circuitry) such as an LSI, an ASIC, an FPGA, or a GPU or may be realized by software and hardware in cooperation. The program may be stored in a storage device such as an HDD or a flash memory in advance or may be stored in a detachable storage medium such as a DVD or a CD-ROM and the storage medium may be mounted in a drive device so that the program is installed. The storage 800 is realized by an HDD, a flash memory, a RAM, a ROM, or the like.

The communicator 710 is, for example, a network card for connection to the network NW. The communicator 710 communicates with a communication device of the vehicle allocation manager 170 or the like of the vehicle 100, the service provider device 600, the service management device 700, the vehicle management device 910, or the like via the network NW and a dedicated application programming interface (API) provided by the service management device 700. Information on the user provided by the dedicated API does not include personal information (for example, a name) of the user. For example, identification information of the vehicle 100 may be used as the user ID.

The service information acquirer 720 acquires service information from a communication device of the vehicle allocation manager 170 or the like of the vehicle 100 via the communicator 710. The service information is, for example, service use request information as will be shown below.

### [Service Use Request Information]

User ID

Position information (latitude, longitude, and altitude)

Desired use service ID

Desired use section information

Information on a service usage time period desired by the user

Payment authentication information

Further, the service information acquirer 720 may acquire the service provision information from the service provider device 600. The service information acquirer 720 acquires point information corresponding to a service provision point, identification information of the service provider, and identification information of a user of a service provider in the service provision information, and outputs the acquired information to the plan determiner 740.

The vehicle specifier 730 specifies an available vehicle 100 on the basis of the service use request information and the vehicle information, and generates available vehicle information 820. Specifically, the vehicle specifier 730 compares desired use space (compartment) information, desired use section information, and service usage time period information included in the service use request information with the position information and a compartment use situation included in the vehicle information and specifies, as the available vehicle 100, a vehicle of which the position information and the compartment use situation satisfy conditions included in the service use request information.

The plan determiner 740 specifies an available service that can be enjoyed by the user on the basis of the available vehicle information 820 and the service provision information, and provides information on the specified available service to the vehicle allocation manager 170 of the vehicle 100 of the user.

More specifically, the plan determiner 740 sets a section in which the service provider occupies at least a part (for example, a compartment) of the vehicle 100 on the basis of the available vehicle information 820 and the service provision information, and sets the desired use section information in the service use request information.

Further, when a plurality of service providers sequentially provide a service to a certain user, the plan determiner 740 may set a section to correspond to each of the plurality of service providers.

The plan determiner 740 includes, for example, an access point acquirer 742. The access point acquirer 742 acquires an access point. The access point is, for example, a position at which the user uses the additional service, or a position at which the user or a person in charge of service provision gets on or off to receive the additional service. The access point acquired by the access point acquirer 742 may be actually measured position information (latitude, longitude, and altitude) or may be estimated position information.

As another function, the plan determiner 740 may update a use section so that the use section ends at the service provision point outside the vehicle, according to an instruction from the user who has used the vehicle 100. In this case, the plan determiner 740 may determine an operation plan according to an instruction from the user who has used the vehicle 100 (or automatically), transmit reservation information to the facility present at the service provision point outside the vehicle using the communicator 710, receive a reservation result using the communicator 710, and transmit the reservation result to the vehicle 100 of the user using the communicator 710.

Further, when the target time of arrival at the facility needs to be changed by the user ordering the additional service, the plan determiner 740 transmits an adjustment of change of the target arrival time to the facility terminal 200 and the pick-up/drop-off management device 400 via the communicator 710. Since a process that is performed by the plan determiner 740 in this case is the same as a process that is performed when the time of arrival according to the status manager 435 of the pick-up/drop-off management device 400 or the time of arrival at the destination is delayed, detailed description of the process will be omitted.

The route indicator 750 causes the communicator 710 to transmit information on a use start position and a use end position of the user and information on a use start position and a use end position of the service provider to the vehicle 100, thereby indicating a route in which the vehicle 100 is to travel, to the vehicle 100.

The authenticator 760 performs user authentication through communication with the vehicle allocation manager 170 or performs authentication at the time of service provision start.

The determiner 770 determines whether or not each of the user and the service provider is using the vehicle 100.

The plan determiner 740 performs various processes using a determination result of the determiner 770. For example, the plan determiner 740 may allow change of a service provision section to be accepted (updated) only when the determiner 770 has determined that both the user and the service provider are using the vehicle 100. This case occurs, for example, when the service provider adds a stopover through proposal to the user or changes a final destination for provision of an additional service on the basis of information provided to the vehicle 100. Further, the plan determiner 740 may allow the vehicle 100 that is being used to be preferentially allocated to the user when the determiner 770 has already determined that the user is using the vehicle 100 (that is, when a request for service extension or another service has been made during the use of the service) at a point in time when the service information acquirer 720 has received the service use request information.

Service management information 830 is stored in the storage 800 in addition to user information 810 on registered users and the available vehicle information 820 described above. The service management information 830 includes, for example, service request management information 832, reservation management information 834, and executed service management information 836. Each piece of the service use request information acquired by the service information acquirer 720 is registered as a record in the service request management information 832. Information such as a reservation use section, a reservation usage time period, a stopover, and a scheduled stopover arrival time is stored for each service in the reservation management information 834. The service status information or information such as a service attribute and a service provider ID (service provider identification information) is registered in the executed service management information 836. The service attribute is, for example, information for classifying services that can be provided by the service provider when viewed from the user receiving information from the service provider, and the service management device 700, and is, for example, a value indicating a business category (food, retail, and the like) of the service provider, a rank of a cost category, or the like.

The service status information held in the executed service management information 836 is updated, for example, at a timing at which the authenticator 760 performs an authentication process for start of the service. The service management device 700 can manage the service management information 830 to comprehensively manage a status of the user of the vehicle 100 (for example, user information acquired by the inputter and outputter 171) and a status for an operation plan of the vehicle 100. Further, the determiner 770 may use, as a determination result, a status attribute determined from use information of the user and operation information of the vehicle 100 (for example, information such as abandonment of enjoyment of the additional service due to the user prioritizing an arrival time), from the service status information.

Further, the status attribute determined from the use information of the user and the operation information of the vehicle 100 includes a value indicating, for example, an attribute (for example, rainy weather, a traffic jam, traffic regulation, low state of charge (low SoC), failure, or accident) of a surrounding environment and a driving status that is determined on the basis of sensing data of the vehicle 100, in addition to a degree of arrival (for example, earlier than scheduled, on-time, and later than scheduled) that is determined on the basis of progress with respect to the operation plan including the additional service.

### [Vehicle Management Device]

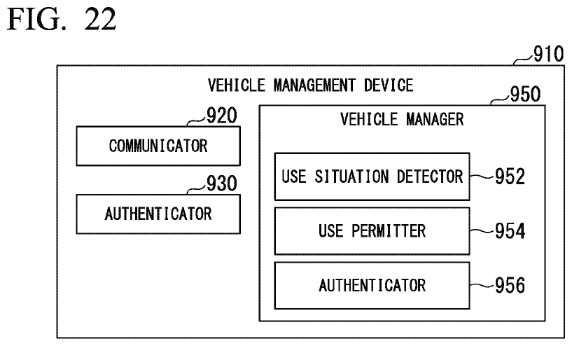

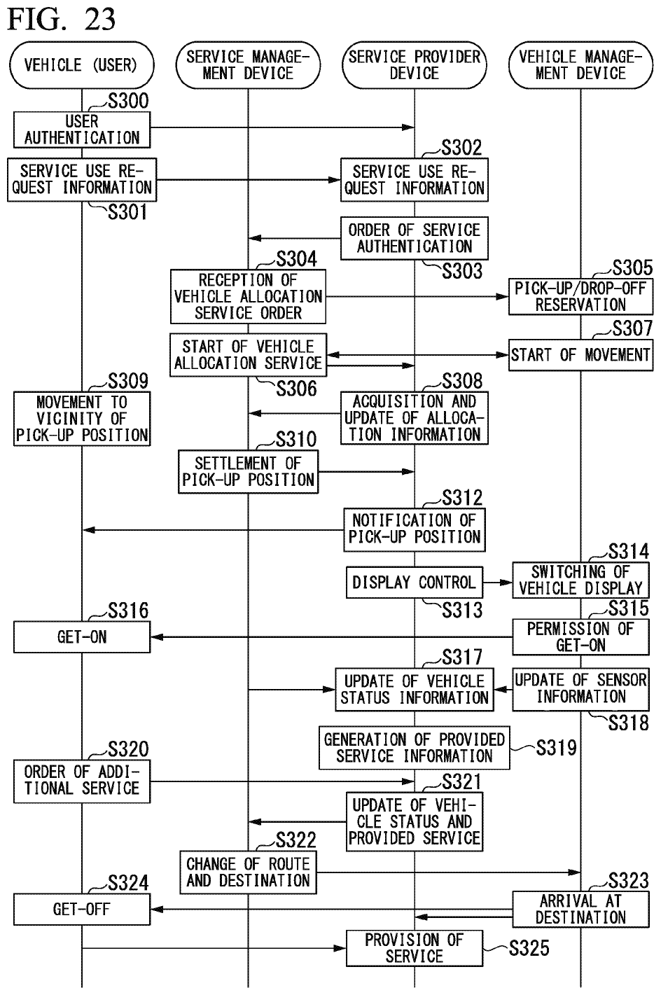

FIG. 22 is a functional configuration diagram of the vehicle management device 910 mounted in the vehicle 100. The vehicle management device 910 includes, for example, a communicator 920, an authenticator 930, and a vehicle manager 950.

The communicator 920 is a wireless communication device. The communicator 920 communicates with the service management device 700 via the network NW. The authenticator 930 performs an authentication process for service start according to an instruction from the service management device 700.

The vehicle manager 950 includes, for example, a use situation detector 952, a use permitter 954, and an authenticator 956. One or more spaces (compartments) that can be used by the user are provided in the vehicle 100, and the use situation detector 952 detects a use situation of each compartment. For example, the use situation detector 952 detects whether or not each compartment is being used. The vehicle 100 is not limited to a normal passenger car, and may be a vehicle having a size allowing one or more occupants to get in respective compartments dividing a vehicle cabin, such as a trailer, a bus, and a microbus. For example, when the authentication of the authenticator 956 has been successful, the use permitter 954 permits use of a compartment designated in advance and performs, for example, unlocking a door. The authenticator 956 performs authentication such as identification of the service provider who has got on the vehicle.

The vehicle management device 910 transmits, for example, vehicle information including the following content to the service management device 700.

### [Vehicle Information]

Vehicle ID

Position information (latitude, altitude, and longitude)

Compartment use situation

Traveling status (speed, acceleration, angular velocity, status of vehicle device, and the like)

Service provider information (ID of service provider, information on service that is being executed, elapsed service performance time, and the like)

FIG. 22 is a flowchart showing an example of a flow of a process that is executed in the vehicle allocation system 1A. In the following example, the flow of the process will be described using an example in which the additional service is ordered by the service provider during get-on, and the user gets off at a destination (an additional service providing position) different from an original destination set by the user.

First, the user performs user authentication on the inputter and outputter 171 of the vehicle 100 with respect to the authenticator 760 of the service management device 700 (step S300). Then, the user transmits service use request information to the service provider device 600 (step S301). The service provider device 600 interprets the received service use request information (step S302), and transmits reservation information to the service management device 700 on the basis of the interpreted service use request information (step S303).

The service management device 700 performs a process of receiving an order for a vehicle allocation service on the basis of the reservation information transmitted by the service provider device 600 and transmits order reception information to the vehicle management device 910 (step S304). The vehicle management device 910 causes the pick-up/drop-off management device 400 to generate a pick-up/drop-off reservation on the basis of the received order reception information (step S305).

The service management device 700 starts the vehicle allocation service for the user on the basis of the order reception information (step S306), and transmits an indication that the service has been started to the service provider device 600 and the vehicle management device 910. The vehicle management device 910 recognizes the start of service and notifies the vehicle 100 or the like of the start of service using a dedicated API (step S307).

The service provider device 600 starts acquisition and update of the vehicle allocation information of the vehicle 100 (step S308). The vehicle 100 starts movement to the vicinity of the pick-up position (step S309). The service management device 700 settles the pick-up position and transmits the pick-up position to the service provider device 600 (step S310). The service provider device 600 notifies the vehicle 100 of the pick-up position (step S312), and transmits a display control instruction to the inputter and outputter 171 via the vehicle management device 910 (step S313). The vehicle management device 910 switches a vehicle display to the inputter and outputter 171 (step S314).

The vehicle management device 910 permits the user to get on the vehicle 100 at the pick-up position (step S315), and the user gets on the vehicle 100 (step S316). The service provider device 600 updates the vehicle status information (step S317), and the vehicle management device 910 updates sensor information (step S318).

The service provider device 600 generates information on additional services that can be provided and outputs the information to the inputter and outputter 171 or the like (step S319). The user selects and orders the additional service (step S320). The service provider device 600 updates the vehicle status and the service use request information on the additional service to be provided, and transmits updated content to the service management device 700 (step S321).

The service management device 700 performs a process according to a change in the route and the destination with the provision of the additional service, and transmits a processing result to the vehicle management device 910 (step S322).

The vehicle management device 910 notifies the service provider device 600 that the vehicle has arrived at the destination (step S323). The user gets off the vehicle 100 (step S324). The service provider device 600 starts providing the additional service to the user (step S325). Then, the process of this flowchart ends.

Forms for implementing the present invention have been described above using the embodiments, but the present invention is not limited to such embodiments at all and various modifications and substitutions can be made without departing from the gist of the present invention.

For example, the status manager 435 may transmit information for accepting change of the vehicle allocation together with information for confirming the vehicle allocation cancelation to the user terminal 300 using the communication device 410. The user may notify the pick-up/drop-off management device 400 of, for example, an instruction of change of the pick-up position with respect to the user terminal 300. The status manager 435 of the pick-up/drop-off management device 400 may notify the vehicle 100 of the changed pick-up position to instruct route changing or transmit change content to the user terminal 300.

Further, a configuration of all or a part of the pick-up/drop-off management device 400 may be mounted in the vehicle 100. Accordingly, for example, the user can directly request the vehicle 100 to perform pick-up/drop-off using the user terminal 300. Further, when the vehicle 100 receiving the request cannot perform the pick-up/drop-off, the vehicle 100 may transfer a pick-up/drop-off request to another vehicle 100.

Further, when the pick-up/drop-off management device 400 has received the time of arrival at the pick-up position or the time of arrival at the destination designated by the user using the user terminal 300, the pick-up/drop-off management device 400 may create the pick-up/drop-off schedule on the basis of these pieces of information and the facility reservation information.

Further, the user terminal 300 may periodically transmit information indicating a position of the user measured by the GNSS receiver 360 to the pick-up/drop-off management device 400. The pick-up/drop-off management device 400 may track a current position of the user and a current position of the vehicle 100 on the basis of the received information to set the pick-up position as a merging position of the user and the vehicle 100 or change the set pick-up position to the merging position of the user and the vehicle 100. Further, the vehicle 100 may set the merging position of the user and the vehicle 100 as the pick-up position on the basis of position information of the user received from the pick-up/drop-off management device 400 and position information of the host vehicle, and set a route of the host vehicle.

Further, the user terminal 300 can accept a vehicle allocation cancelation instruction through various operations. For example, the user terminal 300 receives information for confirming vehicle allocation cancelation, and notifies the user of the information using the outputter 330. Thereafter, the user terminal 300 may accept an extension instruction, a vehicle allocation cancelation instruction, or the like from the user using the inputter 320. When no instruction is input using the inputter 320 within a certain period of time, the user terminal 300 may accept both a facility reservation and a vehicle allocation reservation.

Further, when vehicle allocation for a return route is also reserved, the user may reserve the time of arrival at the pick-up position in advance and request the pick-up/drop-off management device 400 to perform pick-up using the user terminal 300 when leaving the facility.

Further, when there is a user for which the pick-up/drop-off schedule is similar before the vehicle allocation timing, the pick-up/drop-off management device 400 may reconstitute a pick-up/drop-off schedule in which users in a different group are caused to get on together using the same vehicle, and allocate the vehicle 100. For example, there is a case in which a user who has arrived at the same airport on the same flight is picked up/dropped off at the same hotel, or a case in which the user is picked up/dropped off from the same hotel to another nearby restaurant. The facility side can curb a cost of the vehicle allocation by realizing carpool with the vehicle 100 in this way. In this case, the facility side may provide an incentive to the user.

Further, the service management device 700 may manage the vehicle allocation reservation instead of the pick-up/drop-off management device 400, or both the pick-up/drop-off management device 400 and the service management device 700 may manage the vehicle allocation reservation.

### REFERENCE SIGNS LIST

1 Vehicle allocation system
100 Vehicle
110 Outside world monitor
120 Communication device
130 Navigation device
140 Recommended lane determination device
150 Automated driving controller
160 Driving force output device
162 Brake device
164 Steering device
170 Vehicle allocation manager
171 Input and outputter
172 Storage
173 Vehicle allocation controller
174 Status acquirer
175 User information acquirer
176 Order acquirer
200 Facility terminal
210 Communication device
220 Inputter
230 Outputter
240 Storage
250 Controller
300 User terminal
310 Communication device
320 Inputter
330 Outputter
340 Storage
350 Controller
360 GNSS receiver
400 Pick-up/drop-off management device
410 Communication device
420 Storage
430 Controller
431 Facility reserver
432 Vehicle allocation reserver
433 Vehicle allocation manager
434 Acquirer
435 Status manager
600 Service provider device
610 Communicator
620 Order reception processor
630 Status manager
650 Storage
700 Service management device
710 Communicator
720 Service information acquirer
730 Vehicle specifier
740 Plan determiner
742 Access point acquirer
750 Route indicator
760 Authenticator
770 Determiner
800 Storage
810 User information
820 Available vehicle information
830 Service management information
832 Service request management information
834 Reservation management information
836 Executed service management information
910 Vehicle management device
910 Vehicle management system
920 Communicator
930 Authenticator
950 Vehicle manager
952 Use situation detector
954 Use permitter
956 Authenticator

What is claim is:

1.-15. (canceled)

16. A pick-up/drop-off management device comprising:
a vehicle allocation reserver configured to create a pick-up/drop-off schedule on the basis of content of a reservation for a facility and reserve a vehicle;
a vehicle allocation manager configured to allocate the vehicle reserved by the vehicle allocation reserver according to the pick-up/drop-off schedule;
an acquirer configured to acquire information including at least a movement situation from the vehicle allocated by the vehicle allocation manager; and
a status manager configured to notify at least one of a user terminal used by a user who has made the reservation for the facility and a facility terminal used by an administrator of the facility of the information acquired by the acquirer.

17. The pick-up/drop-off management device according to claim 16, wherein the vehicle allocation reserver creates the pick-up/drop-off schedule allowing a vehicle to arrive in time for a designated arrival time, with the facility set as a destination or a departure place, on the basis of the content of the reservation for the facility.

18. The pick-up/drop-off management device according to claim 16, wherein the status manager notifies the facility terminal that a user has got on the vehicle allocated by the vehicle allocation manager and then has started a movement to the facility, or of a target time of arrival at the facility.

19. The pick-up/drop-off management device according to claim 16, wherein the status manager accepts at least one of change or cancelation of a reservation for vehicle allocation and change or cancelation of the reservation for the facility when an arrival time of the vehicle allocated by the vehicle allocation manager is delayed.

20. The pick-up/drop-off management device according to claim 19, wherein the status manager accepts both the cancelation of the vehicle allocation and the cancelation of the facility when neither the cancelation of the vehicle allocation nor extension of a usage time of the facility is acceptable from the user notified of the delay in the arrival time of the vehicle allocated by the vehicle allocation manager.

21. The pick-up/drop-off management device according to claim 16,
wherein the acquirer acquires information indicating the number of occupants from the vehicle, and
the status manager notifies the facility terminal of change of the number of reserved persons when the information indicating the number of occupants acquired by the acquirer is different from the number of reserved persons.

22. The pick-up/drop-off management device according to claim 16,
wherein the acquirer acquires an order indication for a service or product provided by the facility from the vehicle, and
the status manager notifies the facility terminal of the order indication acquired by the acquirer.

23. The pick-up/drop-off management device according to claim 16, further comprising:
a service information acquirer configured to acquire service provision information including point information corresponding to a service provision point, identification information of the service provider, and identification information of a user of the service provider from the service provider;
an access point acquirer configured to acquire an access point that is information on the point at which the user receives the service provision; and
a plan determiner configured to determine an operation plan of the vehicle corresponding to a route between the point information and the access point.

24. The pick-up/drop-off management device according to claim 23, further comprising:
a status manager configured to generate service status information corresponding to the service information and the identification information of the user acquired by the acquirer, and provide the service status information on a service provided at least on the route of the vehicle.

25. The pick-up/drop-off management device according to claim 24, wherein the plan determiner acquires the identification information of the user associated with the service status information, generates the service status information on the basis of an operation plan of the vehicle determined by the plan determiner, and makes the operation plan.

26. The pick-up/drop-off management device according to claim 25, wherein the plan determiner manages a status attribute discriminated from identification information of the user and the movement situation as the service status information, and makes the operation plan.

27. The pick-up/drop-off management device according to claim 24, wherein the plan determiner notifies the facility terminal of information on a time of arrival at the facility in the service status information.

28. A pick-up/drop-off management method comprising:
creating, by a computer, a pick-up/drop-off schedule on the basis of content of a reservation for a facility and reserving a vehicle;
allocating, by the computer, the reserved vehicle according to the pick-up/drop-off schedule;
acquiring, by the computer, information including at least a movement situation from the vehicle; and
notifying, by the computer, at least one of a user terminal used by a user who has made the reservation for the facility and a facility terminal used by an administrator of the facility of the information.

29. A non-transitory computer-readable storage medium that stores an in-vehicle control program to be executed by an in-vehicle computer to perform at least:
create a pick-up/drop-off schedule on the basis of content of a reservation for a facility and reserve a vehicle;
allocate the reserved vehicle according to the pick-up/drop-off schedule;
acquire information including at least a movement situation from the vehicle; and
notify at least one of a user terminal used by a user who has made the reservation for the facility and a facility terminal used by an administrator of the facility of the information.
